(19) United States
(12) Patent Application Publication
(10) Pub. No.: US 2019/0073226 A1
(43) Pub. Date: Mar. 7, 2019

(54) LAYOUT MANAGEMENT FOR MOBILE APPLICATIONS

(71) Applicant: SAP SE, Walldorf (DE)

(72) Inventors: Walter Mak, North Vancouver (CA); Pak Man Chan, Vancouver (CA); Steffen Kötte, Vancouver (CA); Nathan Wang, Port Coquitlam (CA); Michael Tsz Hong Sung, Richmond (CA)

(73) Assignee: SAP SE, Walldorf (DE)

(21) Appl. No.: 15/695,844

(22) Filed: Sep. 5, 2017

(51) Int. Cl. G06F 9/44; G06F 3/0488; H04L 29/08

(52) U.S. Cl. CPC G06F 9/4443; H04L 67/10; H04L 67/04; G06F 3/0488

(57) ABSTRACT

Some embodiments provide a non-transitory machine-readable medium that stores a program. The program generates a plurality of background user interface (UI) pages. The program further receives a request for a layout page comprising a set of locations for presenting a set of visualizations. The program also instructs the plurality of background UI pages to process a subset of the set of visualizations. The program further presents the processed subset of the set of visualizations in the corresponding locations of the layout page.

### BACKGROUND

Many different types of computing devices available today. Examples include desktop computers, servers, laptops, tablets, smartphones, video game consoles, media players, etc. Mobile computing devices such as tablets, smartphones, wearables, etc. are typically smaller in size compared to stationary computing devices (e.g., desktop computers, servers, etc.). However, due to their smaller size, mobile computing devices may have less resources (e.g., processors, memory, etc.) compared to the stationary computing devices. As such, mobile computing devices may not be able to handle resource-intensive tasks and applications that the stationary computing devices can handle.

### SUMMARY

In some embodiments, a non-transitory machine-readable medium stories a program. The program generates a plurality of background user interface (UI) pages. The program further receives a request for a layout page comprising a set of locations for presenting a set of visualizations. The program also instructs the plurality of background UI pages to process a subset of the set of visualizations. The program further presents the processed subset of the set of visualizations in the corresponding locations of the layout page.

In some embodiments, a background UI page in the plurality of background UI pages may process a visualization in the subset of the set of visualizations by sending a visualization definition to a computing system, receiving the visualization from the computing system, rendering the visualization on the background UI page, and generating an image of the visualization. Presenting the processed subset of the set of visualizations may include presenting the generated images of the subset of the set of visualizations in the corresponding locations of the layout page.

In some embodiments, the subset of the set of visualizations may be a first subset of the set of visualizations. The program may further receive input to scroll the layout page to display a second subset of the set of visualizations. The program may also instruct the plurality of background UI pages to process the second subset of the set of visualizations. The program may further present the processed second subset of the set of visualizations in the corresponding locations of the layout page. The program may also add a set of jobs for the subset of the set of visualizations to a work queue. Instructing the plurality of background UI pages to process the subset of the set of visualizations may include instructing the plurality of background UI page to process jobs from the work queue. The subset of locations may include locations in the set of locations have been displayed in a display area of a graphical user interface (GUI) through which the layout page is presented.

In some embodiments, a method generates a plurality of background user interface (UI) pages. The method further receives a request for a layout page comprising a set of locations for presenting a set of visualizations. The method also instructs the plurality of background UI pages to process a subset of the set of visualizations. The method further presents the processed subset of the set of visualizations in the corresponding locations of the layout page.

In some embodiments, a background UI page in the plurality of background UI pages may process a visualization in the subset of the set of visualizations by sending a visualization definition to a computing system, receiving the visualization from the computing system, rendering the visualization on the background UI page, and generating an image of the visualization. Presenting the processed subset of the set of visualizations may include presenting the generated images of the subset of the set of visualizations in the corresponding locations of the layout page.

In some embodiments, the subset of the set of visualizations may be a first subset of the set of visualizations. The method may further receive input to scroll the layout page to display a second subset of the set of visualizations. The method may also instruct the plurality of background UI pages to process the second subset of the set of visualizations. The method may further present the processed second subset of the set of visualizations in the corresponding locations of the layout page. The method may also add a set of jobs for the subset of the set of visualizations to a work queue. Instructing the plurality of background UI pages to process the subset of the set of visualizations may include instructing the plurality of background UI page to process jobs from the work queue. The subset of locations may include locations in the set of locations have been displayed in a display area of a graphical user interface (GUI) through which the layout page is presented.

In some embodiments, a system includes a set of processing units and a non-transitory computer-readable medium that stores instructions. The instructions cause at least one processing unit to generate a plurality of background user interface (UI) pages. The instructions further cause the at least one processing unit to receive a request for a layout page comprising a set of locations for presenting a set of visualizations. The instructions also cause the at least one processing unit to instruct the plurality of background UI pages to process a subset of the set of visualizations. The instructions further cause the at least one processing unit to present the processed subset of the set of visualizations in the corresponding locations of the layout page.

In some embodiments, a background UI page in the plurality of background UI pages may process a visualization in the subset of the set of visualizations by sending a visualization definition to a computing system, receiving the visualization from the computing system, rendering the visualization on the background UI page, and generating an image of the visualization. Presenting the processed subset of the set of visualizations may include presenting the generated images of the subset of the set of visualizations in the corresponding locations of the layout page.

In some embodiments, the subset of the set of visualizations may be a first subset of the set of visualizations. The instructions may further cause the at least one processing unit to receive input to scroll the layout page to display a second subset of the set of visualizations. The instructions may also cause the at least one processing unit to instruct the plurality of background UI pages to process the second subset of the set of visualizations. The instructions may further cause the at least one processing unit to present the processed second subset of the set of visualizations in the corresponding locations of the layout page. The instructions may also cause the at least one processing unit to add a set of jobs for the subset of the set of visualizations to a work queue. Instructing the plurality of background UI pages to process the subset of the set of visualizations may include instructing the plurality of background UI page to process jobs from the work queue.

The following detailed description and accompanying drawings provide a better understanding of the nature and advantages of the present invention.

### BRIEF DESCRIPTION OF THE DRAWINGS

FIG. 1 illustrates a system according to some embodiments.

FIGS. 2A-2D illustrate an example of presenting a visualization collection according to some embodiments.

FIG. 3 illustrates an example layout page for a visualization collection according to some embodiments.

FIGS. 4A-4C illustrate another example of presenting a visualization collection according to some embodiments.

FIGS. 5A-5C illustrate another example of presenting a visualization collection according to some embodiments.

FIGS. 6A-6G illustrate an example of reordering a work queue when presenting a visualization collection according to some embodiments.

FIGS. 7A-7E illustrate an example of interacting with a visualization in a visualization collection according to some embodiments.

FIG. 8 illustrates a process for presenting a visualization collection according to some embodiments.

FIG. 9 illustrates an exemplary computer system, in which various embodiments may be implemented.

FIG. 10 illustrates an exemplary computing device, in which various embodiments may be implemented.

FIG. 11 illustrates system for implementing various embodiments described above.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Described herein are techniques for interacting with a visualization collection on a mobile device. In some embodiments, a visualization collection includes one or more visualizations of data (e.g., chart visualization such as bar charts, pie charts, line charts, scatter charts, etc.). The mobile device may operate in two modes: a collection mode and an interaction mode. When operating in the collection mode, the mobile device presents all the visualizations in the visualization collection. When operating in the interaction mode, the mobile device presents a visualization in the visualization collection and allows interaction with the presented visualization.

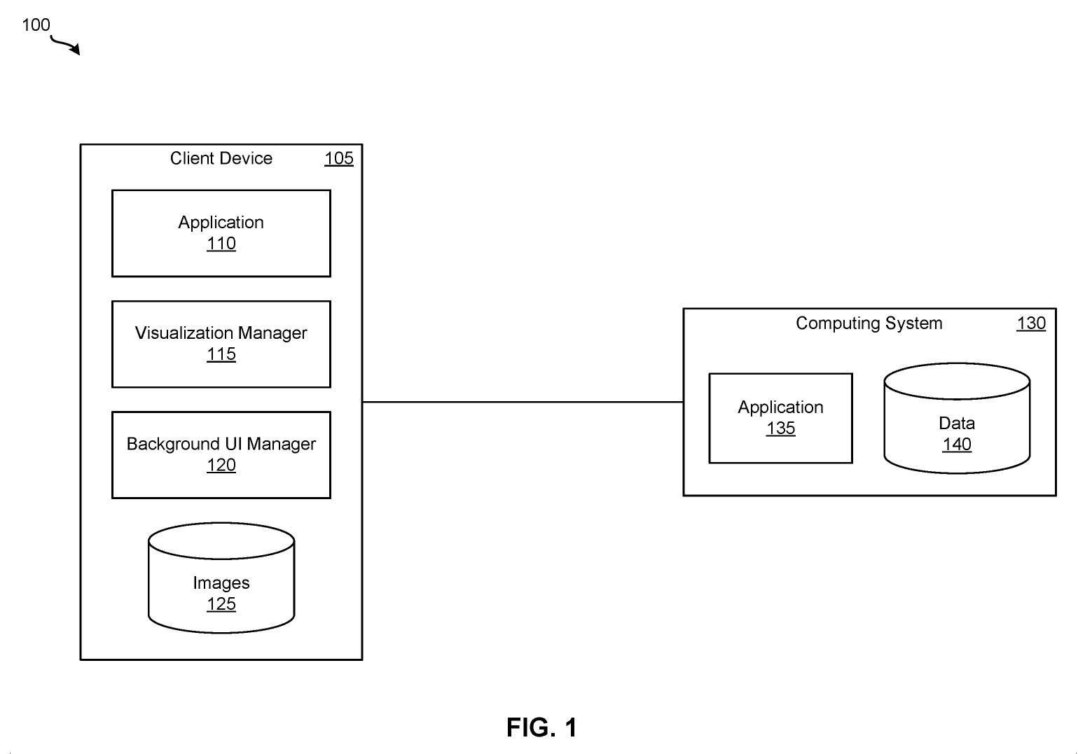

FIG. 1 illustrates system 100 according to some embodiments. As shown, system 100 includes client device 105 and computing system 130. As illustrated, client device 105 includes application 110, visualization manager 115, background user interface (UI) manager 120, and images storage 125. Images storage 125 is configured to store images of visualizations. In some embodiments, images storage 125 is implemented in a single physical storage while, in other embodiments, images storage 125 may be implemented across several physical storages. While FIG. 1 shows images storage 125 as part of client device 105, one of ordinary skill in the art will appreciate that images storage 125 may be external to client device 105 in some embodiments. Application 110 may be a software application operating on client device 105. Application 110 may be any number of different types of applications. For instance, application 110 may be an analytics application, a data management application, a human capital management application, an enterprise management application, a customer relationship management application, a financial management application, etc.

As shown in FIG. 1, computing system 130 includes application 135 and data storage 140. Data storage 140 is configured to store data used for visualizations and authentication records (e.g., records that include a username and a password). In some embodiments, storage 140 is implemented in a single physical storage while, in other embodiments, storage 140 may be implemented across several physical storages. While FIG. 1 shows storage 140 as part of computing system 130, one of ordinary skill in the art will appreciate that storage 140 may be external to computing system 130 in some embodiments.

Application 135 may be a software application operating on (e.g., hosted on) computing system 130 that may be accessed by client device 105. Application 135 may be any number of different types of applications. For instance, application 135 may be an analytics application, a data management application, a human capital management application, an enterprise management application, a customer relationship management application, a financial management application, etc.

Application 135 may receive requests from client device 105. For instance, application 135 can receive from client device 105 a request to authenticate a user along with authentication information. In response to such a request, application 135 accesses data storage 140 and checks whether data storage 140 stores information that matches the authentication information. For example, if the authentication information includes a username and a password, application 135 determines that the authentication information is valid if data storage 140 stores a record that includes the same username and password as that specified in the authentication information. If so, application 135 sends client device 105 a notification that the authentication information is valid. Otherwise, application 135 sends client device 105 a notification that the authentication information is not valid. As another example, application 135 can receive a request for a visualization of data. In response, application 135 may access data storage 140 to retrieve the requested data, generate the visualization using the retrieved data, and then send the visualization to client device 105.

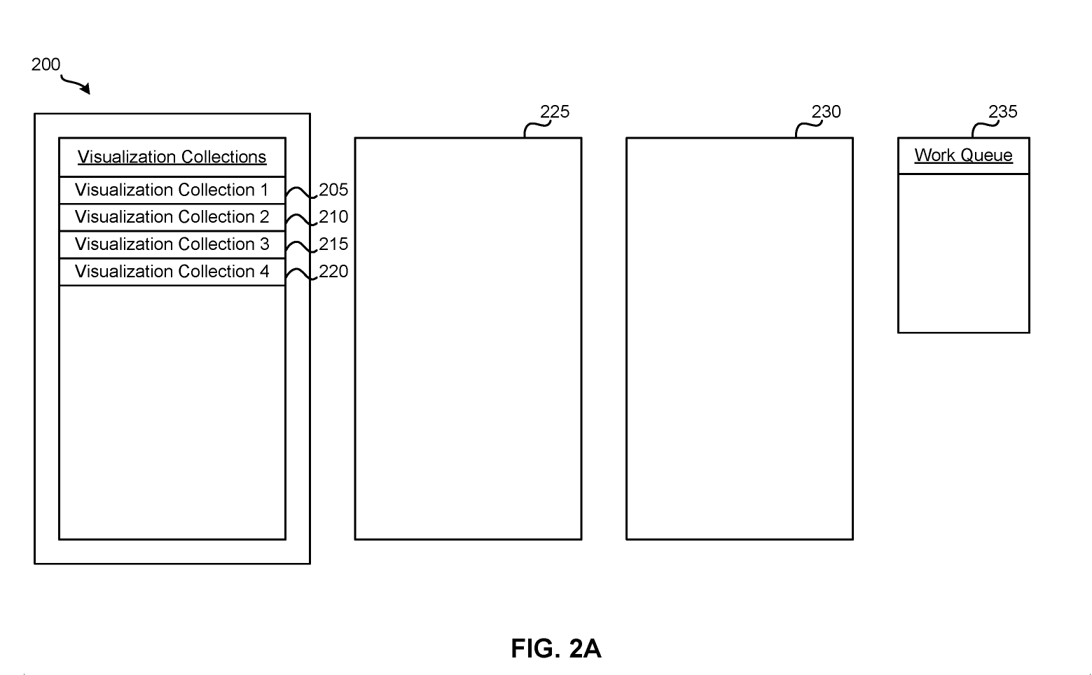

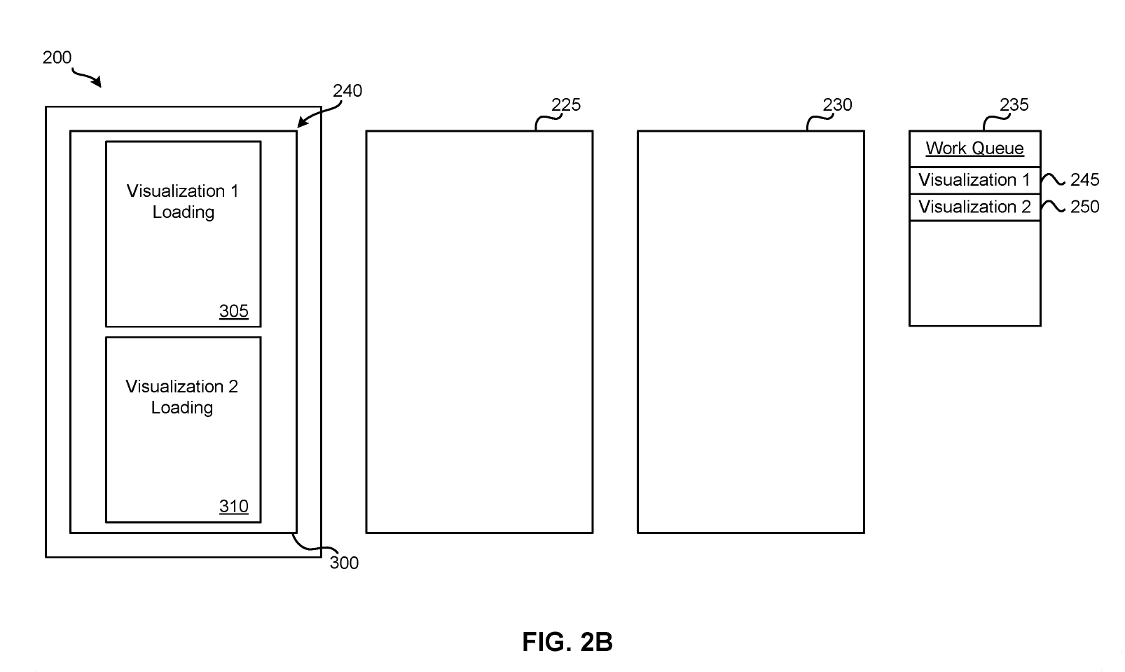

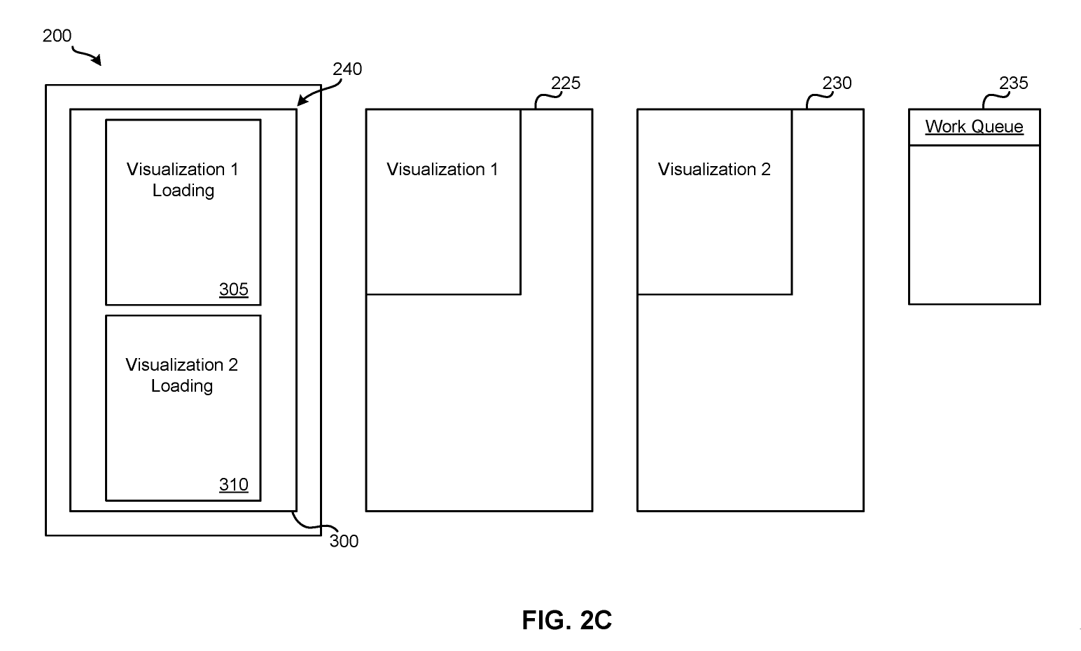

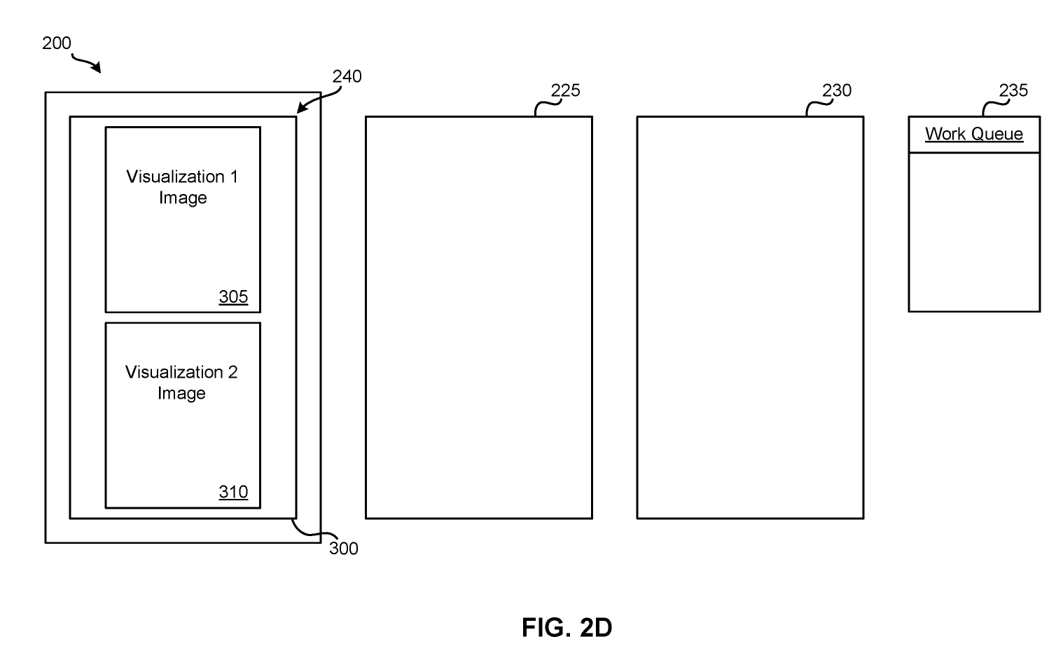

Several example operations of system 100 will now be described by reference to FIGS. 2-6. A first example operation is presenting a visualization collection through a graphical user interface (GUI). The first example operation starts when a user of client device 105 initiates application 110 (e.g., by selecting a selectable user interface (UI) item presented in a GUI provided by client device 105 that is configured to start application 110). When application 110 starts, application 110 may request authentication information (e.g., a username and a password) from the user and then communicate with computing system 130 to determine that the authentication information provided by the user is valid. Once application 110 receives a notification from computing system 130 that the authentication information is valid, application 110 sends computing system 130 a request for visualization collection definitions associated with the user. In some embodiments, a visualization collection definition specifies one or more visualizations that belong to the visualization collection. For each visualization in a visualization collection, the visualization collection definition includes a visualization definition of the visualization. In some embodiments, a visualization definition of a visualization specifies a type of the visualization (e.g., a bar chart visualization, a pie chart visualization, a line chart visualization, a scatter chart visualization, etc.), a title of the visualization, a set of queries for data for the visualization, and a data source of the data for the visualization. In some instances, a visualization definition may specify additional and/or different information such as a set of filters for the visualization, modeling information associated with the visualization, etc.

Upon receiving the visualization collection definitions associated with the user, application 110 presents a graphical user interface (GUI) that includes selectable user interface (UI) items that represent the visualization collections associated with the user. In addition, application 110 sends background UI manager 120 a request to generate a defined number (e.g., two, four, ten, etc.) of background UI pages. In some embodiments, a background UI page is an out-of-process browser configured to load and/or render web pages while out of view of a user of client device 105 (e.g., not displayed to the user of client device 105). FIG. 2A illustrates an example of such a GUI and background UI pages. As shown, FIG. 2A illustrates GUI 200, background UI pages 225 and 230, and work queue 235. As shown, GUI 200 includes selectable UI items 205-220 that represent visualization collections 1-4, respectively. In this example, UI items 205-220 represent visualization collections associated with the user of client device 105. In this example, application 110 sends background UI manager 120 a request to generate two background UI pages, background UI pages 225 and 230. When background UI manager 120 generates a background UI page, background UI manager 120 retrieves a set of libraries (e.g., a set of Javascript libraries) for processing visualizations from computing system 130 and loads the set of libraries onto the background UI page. This way, the background UI page can process visualizations faster because it preloads the set of libraries loaded and, thus, does not have to retrieve and load the set of libraries each time it processes a visualization. For this example, work queue 235 is part of application 110 and is configured to store jobs to be processed by background UI pages 225 and 230. In some embodiments, work queue 235 may be a component that is separate from application 110.

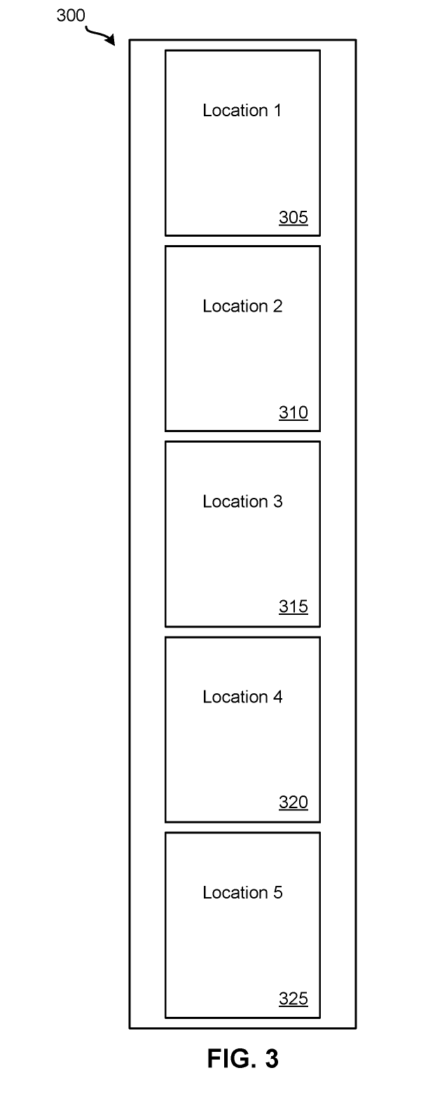

After application 110 presents UI items 205-220 in GUI 200 and background UI manager 130 generates background UI pages 225 and 230, application 110 receives a selection of UI item 210 from the user of client device 105. In this example, the visualization collection associated with UI item 210 includes five visualizations. Accordingly, application 110 presents a layout page for presenting the five visualizations in the visualization collection. FIG. 3 illustrates an example layout page 300 for such a visualization collection according to some embodiments. As shown, layout page 300 includes five locations 305-325 that are configured to present the five visualizations in the visualization collection.

FIG. 2B illustrates GUI 200 after application 110 presents layout page 300 in display area 240 of GUI 200. After application 110 presents layout page 300, application 110 determines the locations 305-325 that are displayed in display area 240 (e.g., the locations 305-325 of layout page 300 that are viewable by the user of client device 105). As shown in FIG. 2B, locations 305 and 310 are displayed in display area 240. Next, application 110 presents notifications in the determined locations 305 and 310 indicating that the corresponding visualizations are loading, as illustrated in FIG. 2B. Application 110 then adds a job to work queue 235 for each visualization that is determined to be displayed in display area 240 by identifying the visualization definition of the corresponding visualization included in the visualization collection definition of visualization collection 2 and then adding it to work queue 235. As shown in FIG. 2B, application 110 added jobs 245 and 250 for visualizations 1 and 2, respectively, of visualization collection 2 to work queue 235.

Once application 110 adds the jobs to work queue 235, application 110 sends background UI manager 120 a request to process jobs in work queue 235. In response, background UI manager 120 instructs background UI pages 225 and 230 to process jobs in work queue 235. In this example, background UI page 225 takes job 245 off the top of work queue 235 and starts processing it and then background UI page 230 takes job 250 off the top of work queue 235 and starts processing it. In some embodiments, a background UI page processes a job in work queue 235 by sending the visualization definition to computing system 130, rendering the visualization received from computing system 130 on the background UI page, generating an image of the visualization, and sending the image to visualization manager 115. When visualization manager 115 receives the image, visualization manager 115 stores it in images storage 125 and then presents the image in the corresponding location of layout page 300. As there are no more jobs in work queue 235, background UI pages 225 and 230 go idle.

FIG. 2C illustrates GUI 200 while background UI pages 225 and 230 are rendering visualizations 1 and 2, respectively. As such, GUI 200 still shows the notifications in locations 305 and 310 that visualizations 1 and 2 are loading. FIG. 2D illustrates GUI 200 after background UI pages 225 and 230 finished processing visualizations 1 and 2, respectively, and sent the images to visualization manager 115. FIG. 2D also shows GUI 200 after visualization manager 115 stored the images in images storage 125 and presented the images in layout page 300. As shown, an image of visualization 1 is presented in location 305 of layout page 300 and an image of visualization 2 is presented in location 310 of layout page 300.

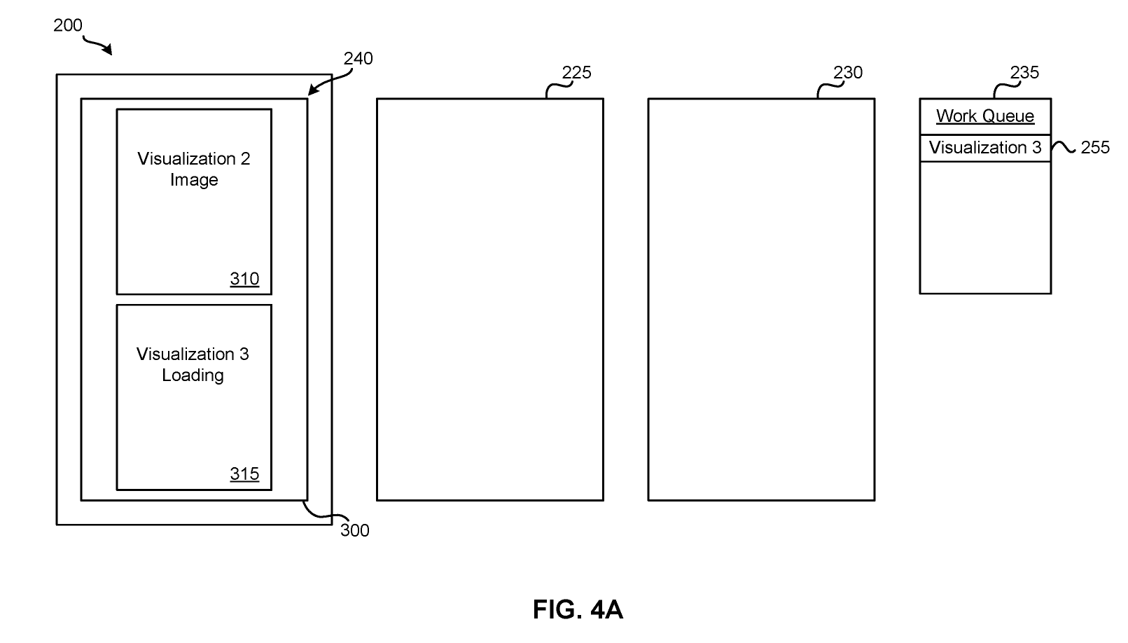

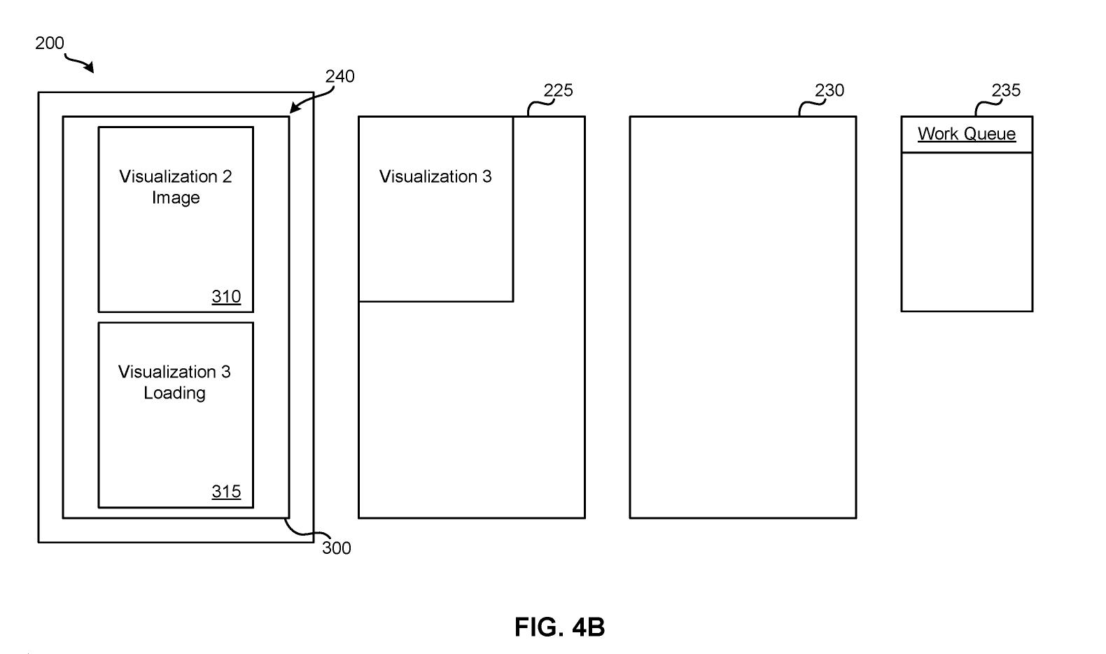

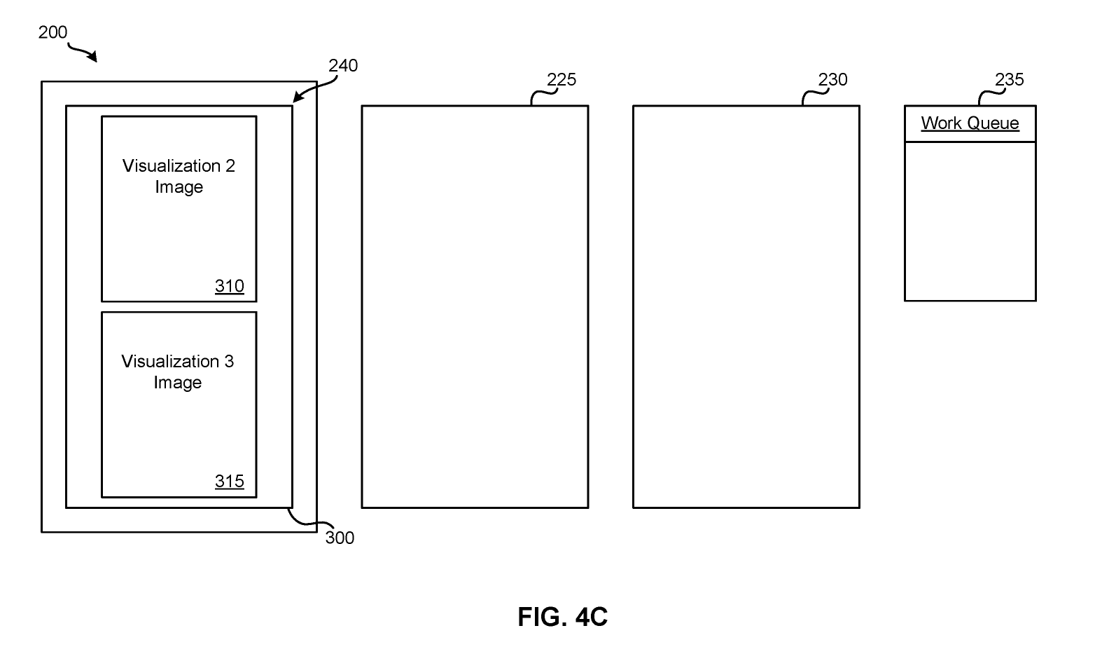

A second example operation is scrolling through a visualization collection presented in a GUI. The second example operation continues from the end of the first example operation described above by reference to FIGS. 2A-2D. In this example, application 110 receives from the user of client device 105 input to scroll layout page 300 in an upwards direction through display area 240. When application 110 receives the input, application 110 scrolls layout page 300 accordingly and determines the locations in layout page 300 that are now displayed in display area 240. As shown in FIG. 4A, locations 310 and 315 are now displayed in display area 240. Application 110 then presents a notification in location 315 indicating that the corresponding visualization is loading, as illustrated in FIG. 4A. Application 110 does not present such a notification since an image of visualization 2 is already presented in its location 310. Application 110 then adds a job to work queue 235 for visualization 3 by identifying the visualization definition of visualization 3, which is included in the visualization collection definition of visualization collection 2, and then adding it to work queue 235. As shown in FIG. 4A, application 110 added job 255 for visualization 3 of visualization collection 2 to work queue 235.

After application 110 adds the job to work queue 235, application 110 sends background UI manager 120 a request to process jobs in work queue 235. In response, background UI manager 120 instructs background UI pages 225 and 230 to process jobs in work queue 235. For this example, background UI page 225 takes job 255 off the top of work queue 235 and starts processing it. Since job 255 is the only job in work queue 235, background UI page 230 does not have any jobs to process and, thus, goes idle. Background UI page 225 processes job 255 by sending the visualization definition of visualization 3 to computing system 130, rendering the visualization received from computing system 130 on background UI page 225, generating an image of the visualization, and sending the image to visualization manager 115. Upon receiving the image, visualization manager 115 stores it in images storage 125 and then presents the image in location 315 of layout page 300. Since there are no more jobs in work queue 235, background UI page 225 goes idle.

FIG. 4B illustrates GUI 200 while background UI page 225 is rendering visualization 3. As such, GUI 200 still shows the notification in location 315 that visualization 3 is loading. FIG. 4C illustrates GUI 200 after background UI page 225 finished processing visualization 3 and sent the image to visualization manager 115. FIG. 4C also illustrates GUI 200 after visualization manager 115 stored the image in images storage 125 and presented the image in layout page 300. As shown, an image of visualization 3 is presented in location 315 of layout page 300.

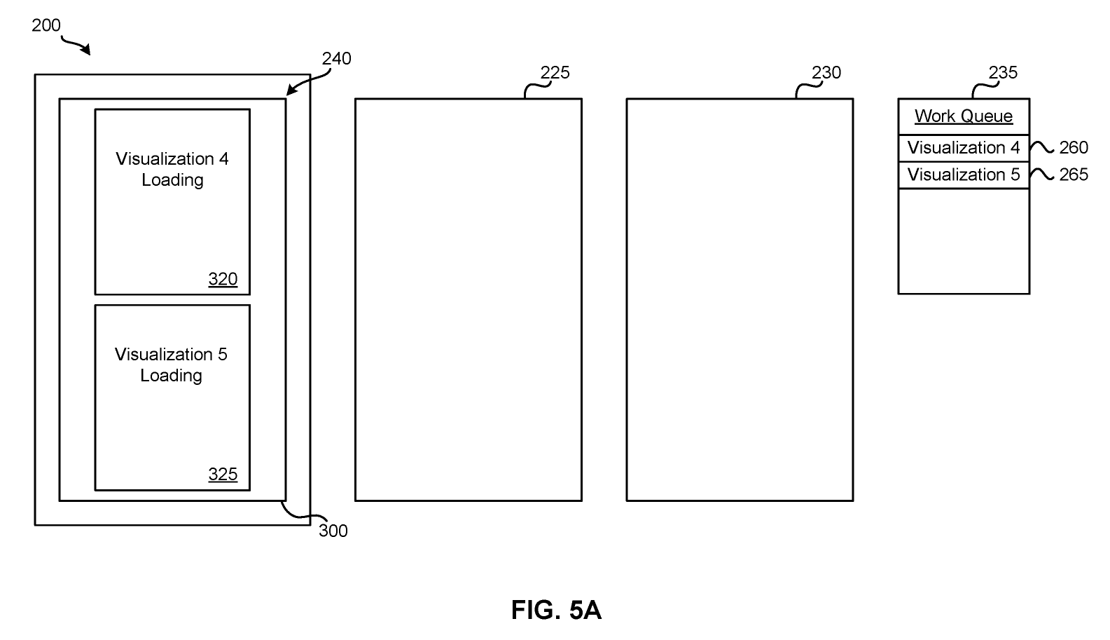

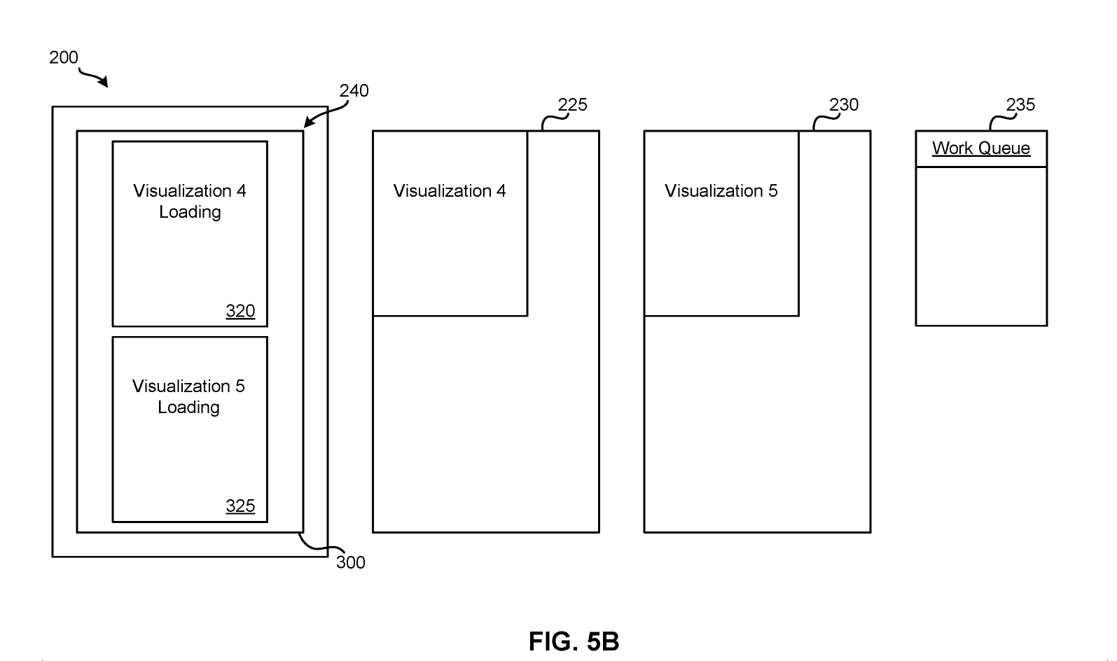

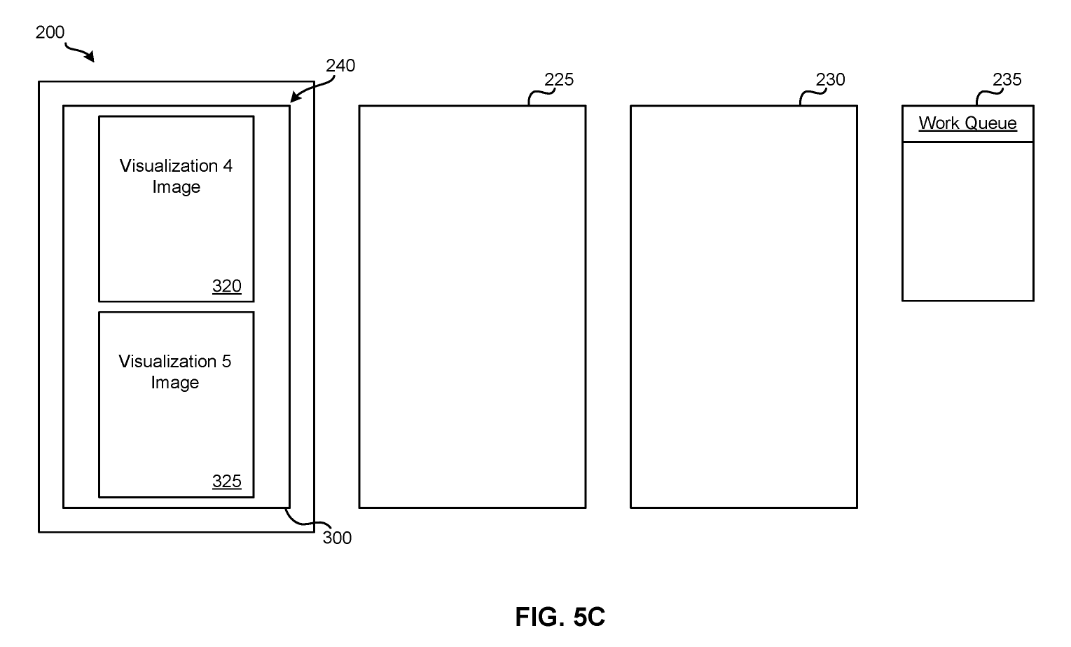

A third example operation is another scrolling through a visualization collection presented in a GUI. The third example operation continues from the end of the second example operation described above by reference to FIGS. 4A-4C. For this example, application 110 receives from the user of client device 105 another input to scroll layout page 300 in an upwards direction through display area 240. Once application 110 receives the input, application 110 scrolls layout page 300 accordingly and determines the locations in layout page 300 that are now displayed in display area 240. As illustrated in FIG. 5A, locations 320 and 325 are now displayed in display area 240. Since the determined locations 320 and 325 do not have images of the corresponding visualizations 4 and 5, respectively, presented in them, application 110 presents notifications in locations 320 and 325 indicating that the corresponding visualizations are loading, as shown in FIG. 5A. Next, application 110 adds jobs to work queue 235 for visualizations 4 and 5 by identifying the visualization definitions of visualizations 4 and 5, which are included in the visualization collection definition of visualization collection 2, and then adding them to work queue 235. As shown in FIG. 5A, application 110 added jobs 260 and 265 for visualizations 4 and 5, respectively, of visualization collection 2 to work queue 235.

Once application 110 adds the jobs to work queue 235, application 110 sends background UI manager 120 a request to process jobs in work queue 235. In response, background UI manager 120 instructs background UI pages 225 and 230 to process jobs in work queue 235. In this example, background UI page 225 takes job 260 off the top of work queue 235 and starts processing it and then background UI page 230 takes job 265 off the top of work queue 235 and starts processing it. Background UI page 225 processes job 260 by sending the visualization definition of visualization 4 to computing system 130, rendering the visualization received from computing system 130 on background UI page 225, generating an image of the visualization, and sending the image to visualization manager 115. Similarly, background UI page 230 processes job 265 by sending the visualization definition of visualization 5 to computing system 130, rendering the visualization received from computing system 130 on background UI page 230, generating an image of the visualization, and sending the image to visualization manager 115. Once visualization manager 115 receives the images, visualization manager 115 stores them in images storage 125. Then, visualization manager 115 presents the images for visualizations 4 and 5 in locations 320 and 325, respectively, of layout page 300. As there are no more jobs in work queue 235, background UI pages 225 and 230 go idle.

FIG. 5B illustrates GUI 200 while background UI pages 225 and 230 are rendering visualizations 1 and 2, respectively. As such, GUI 200 still shows the notification in location 315 that visualization 3 is loading. FIG. 5C illustrates GUI 200 after background UI pages 225 and 230 finished processing visualizations 4 and 5, respectively, and sent the images to visualization manager 115. FIG. 5C also illustrates GUI 200 after visualization manager 115 stored the images in images storage 125 and presented the images in layout page 300. As shown, an image of visualization 4 is presented in location 320 of layout page 300 and an image of visualization 5 is presented in location 325 of layout page 300.

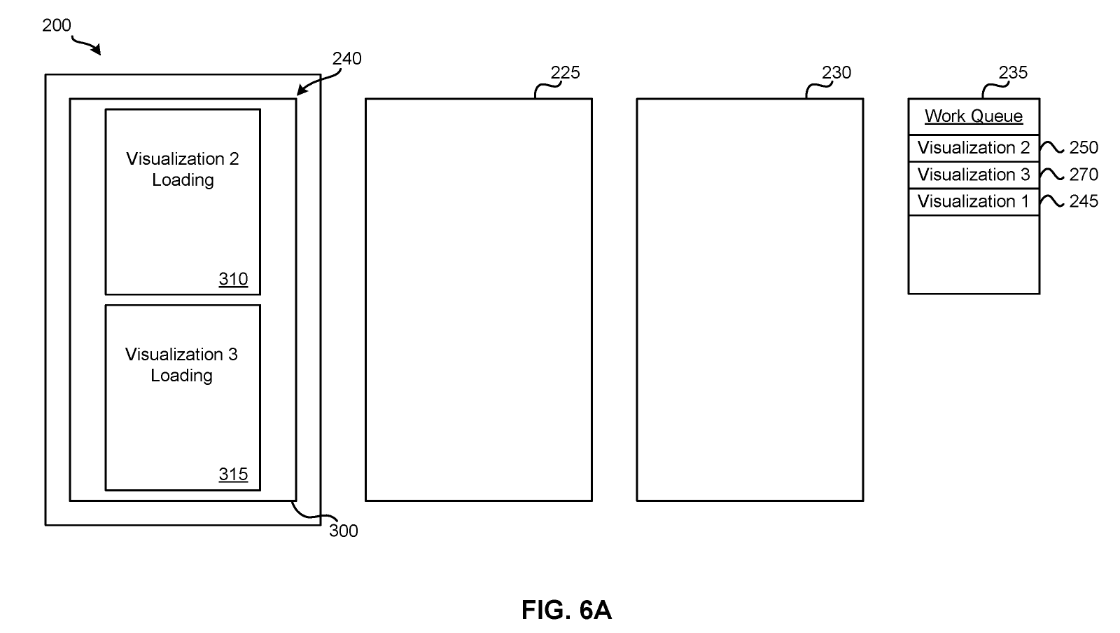

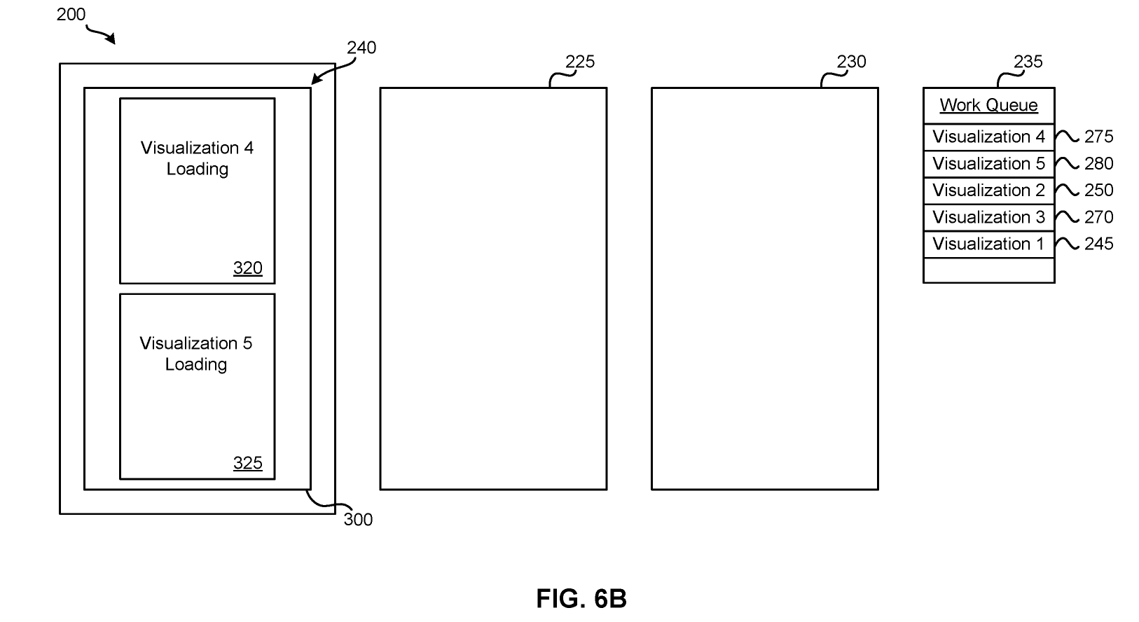

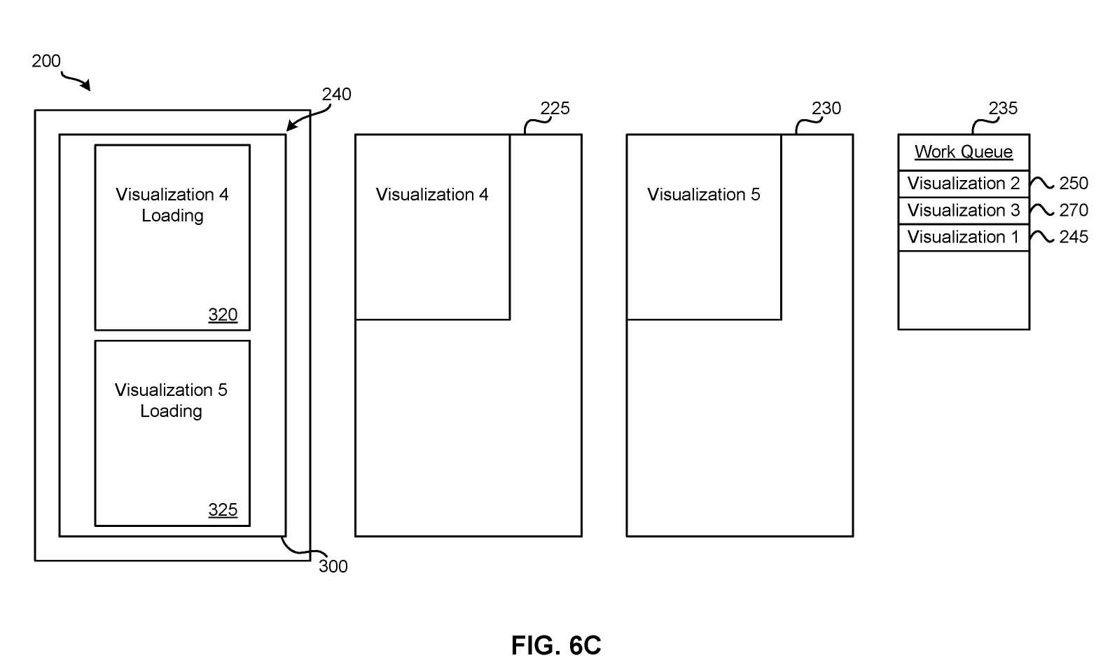

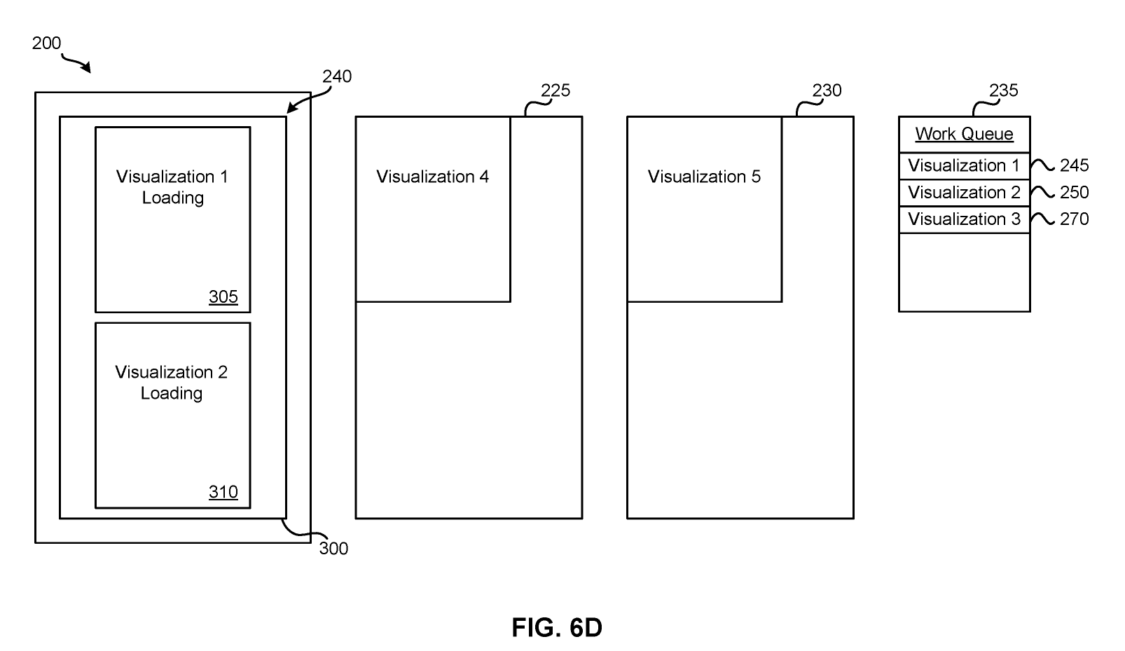

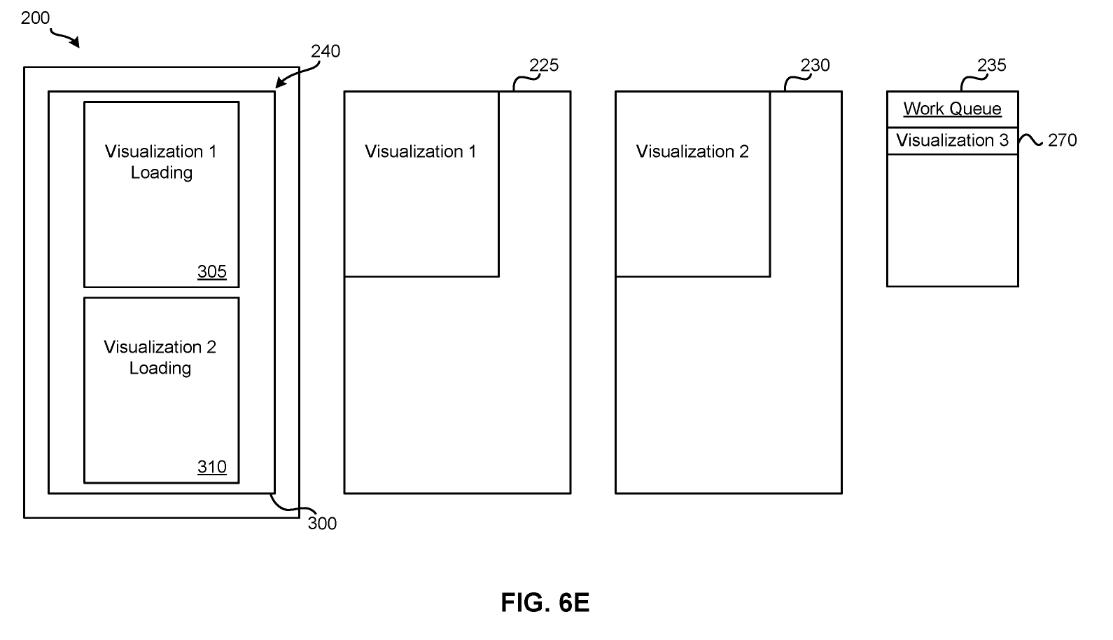

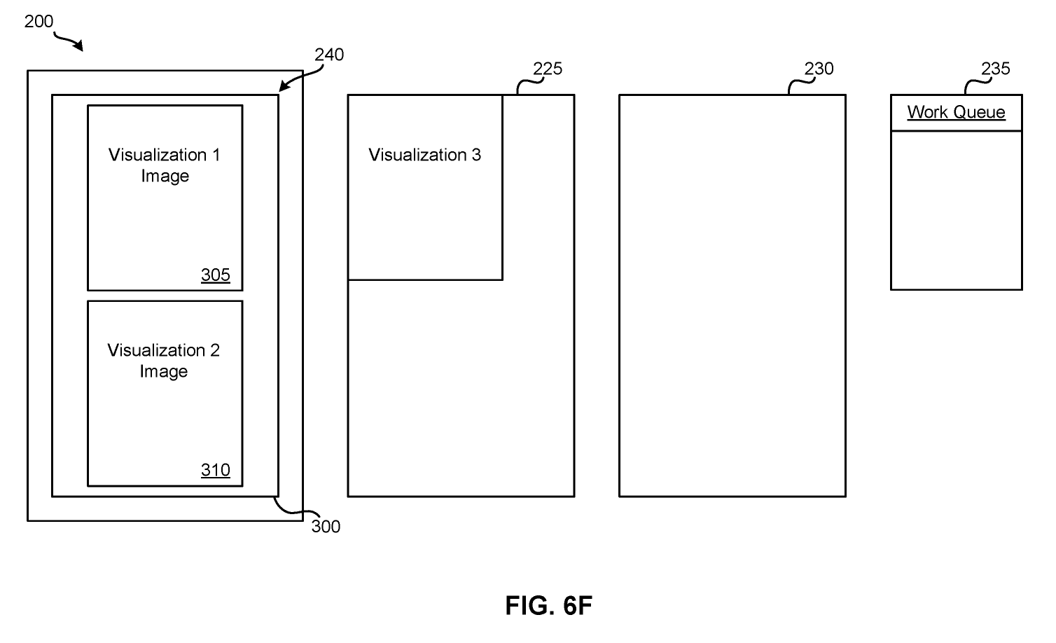

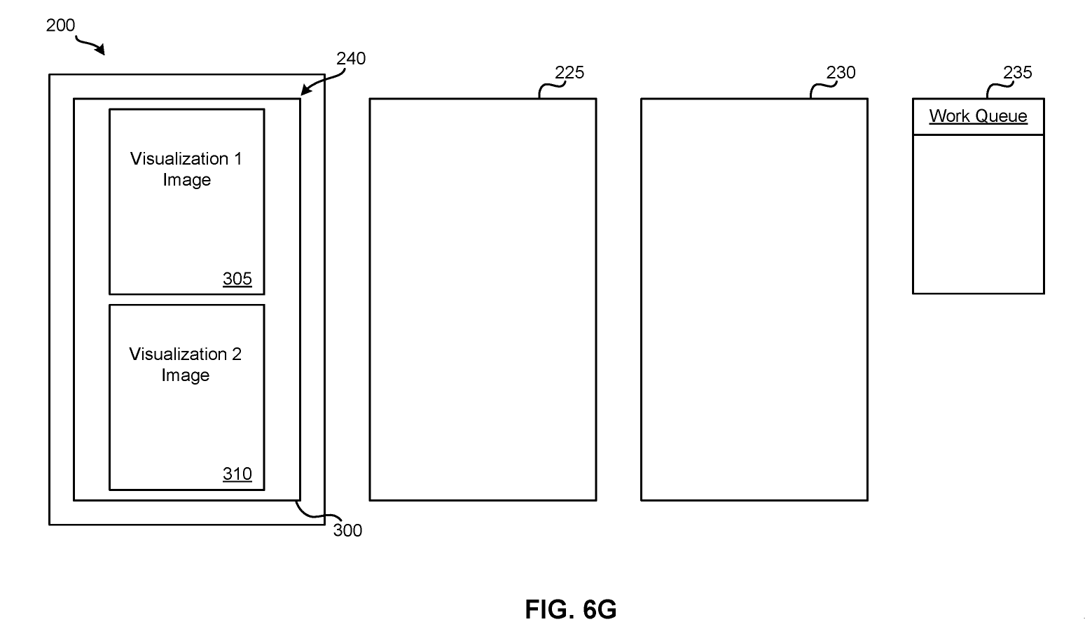

A fourth example operation is reordering a work queue in response to scrolling through a visualization collection presented in a GUI. The fourth example operation continues from the stage of the GUI 200 described above by reference to FIG. 2B. In this example, application 110 receives input from the user of client device 105 within a defined amount of time (e.g., 25 milliseconds (ms), 100 ms, 500 ms, 1 second, etc.) after adding jobs 245 and 250 to work queue 235. As such, application 110 processes the input instead of requesting background UI manager 115 to process jobs in work queue 235. The input for this example is to scroll layout page 300 in an upwards direction through display area 240. When application 110 receives the input, application 110 scrolls layout page 300 accordingly and determines the locations in layout page 300 that are now displayed in display area 240. As shown in FIG. 6A, locations 310 and 315 are now displayed in display area 240. Application 110 then presents a notification in location 315 indicating that the corresponding visualization is loading, as shown in FIG. 6A. Application 110 does not present such a notification since an image of visualization 2 is already presented in its location 310.

Next, application 110 adds a job to work queue 235 for visualization 3 by identifying the visualization definition of visualization 3, which is included in the visualization collection definition of visualization collection 2, and then adding it to work queue 235. Application 110 then reorders the jobs in work queue 235 to prioritize the jobs of visualizations with which locations in layout page 300 that are now displayed in display area 240 are associated. In this example, locations 310 and 315 are now displayed in display area 240. As such, application 110 reorders the jobs in work queue 235 such that the jobs of visualizations with which locations 310 and 315 are associated will be processed first. As illustrated in FIG. 6A, application 110 added job 270 for visualization 3 of visualization collection 2 to work queue 235 and reordered jobs 245, 250, and 270 so that jobs 250 and 270 for visualizations 2 and 3, respectively, are at the top of work queue 235.

In this example, application 110 receives input from the user of client device 105 within the defined amount of time after adding job 270 to work queue 235 and reordering jobs 245, 250, and 270 in work queue 235. Thus, application 110 processes the input instead of requesting background UI manager 115 to process jobs in work queue 235. The input for this example is to scroll layout page 300 in an upwards direction through display area 240. Upon receiving the input, application 110 scrolls layout page 300 accordingly and determines the locations in layout page 300 that are now displayed in display area 240. As illustrated in FIG. 6B, locations 320 and 325 are now displayed in display area 240. Next, application 110 presents notifications in locations 320 and 325 indicating that the corresponding visualizations 4 and 5, respectively, are loading, as shown in FIG. 6B.

Application 110 then adds jobs to work queue 235 for visualizations 4 and 5 by identifying the visualization definitions of visualizations 4 and 5, which are included in the visualization collection definition of visualization collection 2, and then adding them to work queue 235. Next, application 110 reorders the jobs in work queue 235 to prioritize the jobs of visualizations with which locations in layout page 300 that are now displayed in display area 240 are associated. In this example, locations 320 and 325 are now displayed in display area 240. Thus, application 110 reorders the jobs in work queue 235 so that the jobs of visualizations with which locations 320 and 325 are associated will be processed first. As illustrated in FIG. 6B, application 110 added jobs 275 and 280 for visualizations 4 and 5, respectively, of visualization collection 2 to work queue 235 and reordered jobs 245, 250, 270, 275, and 280 so that jobs 275 and 280 for visualizations 4 and 5, respectively, are at the top of work queue 235.

For this example, application 110 does not receive input from the user of client device 105 within the defined amount of time after adding jobs 275 and 280 to work queue 235 and reordering jobs 245, 250, 270, 275, and 280 in work queue 235. As such, application 110 sends background UI manager 120 a request to process jobs in work queue 235. In response, background UI manager 120 instructs background UI pages 225 and 230 to process jobs in work queue 235. In this example, background UI page 225 takes job 275 off the top of work queue 235 and starts processing it and then background UI page 230 takes job 280 off the top of work queue 235 and starts processing it. Background UI page 225 processes job 275 by sending the visualization definition of visualization 4 to computing system 130, rendering the visualization received from computing system 130 on background UI page 225, generating an image of the visualization, and sending the image to visualization manager 115. Similarly, background UI page 230 processes job 280 by sending the visualization definition of visualization 5 to computing system 130, rendering the visualization received from computing system 130 on background UI page 230, generating an image of the visualization, and sending the image to visualization manager 115. FIG. 6C illustrates GUI 200 while background UI pages 225 and 230 are rendering visualizations 4 and 5, respectively. Thus, GUI 200 still shows the notifications in locations 320 and 325 that visualizations 4 and 5, respectively, are loading.

In this example, application 110 receives input from the user of client device 105 before background UI pages 225 and/or 230 finishes processing visualizations 4 and 5, respectively and, thus, processes the input. The input for this example is to scroll layout page 300 in a downwards direction through display area 240. After receiving the input, application 110 scrolls layout page 300 accordingly and determines the locations in layout page 300 that are now displayed in display area 240. As illustrated in FIG. 6D, locations 305 and 310 are now displayed in display area 240. Application 110 then presents notifications in locations 305 and 310 indicating that the corresponding visualizations 1 and 2, respectively, are loading, as shown in FIG. 6D. Next, application 110 reorders the jobs in work queue 235 to prioritize the jobs of visualizations with which locations in layout page 300 that are now displayed in display area 240 are associated. For this example, locations 305 and 310 are now displayed in display area 240. Thus, application 110 reorders the jobs in work queue 235 so that the jobs of visualizations with which locations 305 and 310 are associated will be processed first. As illustrated in FIG. 6D, application 110 reordered jobs 245, 250, and 270 so that jobs 245 and 250 for visualizations 1 and 2, respectively, are at the top of work queue 235.

After background UI pages 225 and 230 finishes processing visualizations 4 and 5, respectively, visualization manager 115 receives the images of them and stores them in images storage 125. For this example, application 110 does not receive input from the user of client device 105 within the defined amount of time after background UI pages 225 and 230 finishes processing visualizations 4 and 5, respectively. Because there are additional jobs in work queue 235, background UI pages 225 and 230 continue processing jobs in work queue 235. Specifically, background UI page 225 takes job 245 off the top of work queue 235 and starts processing it and then background UI page 230 takes job 250 off the top of work queue 235 and starts processing it. Background UI page 225 processes job 245 by sending the visualization definition of visualization 1 to computing system 130, rendering the visualization received from computing system 130 on background UI page 225, generating an image of the visualization, and sending the image to visualization manager 115. Similarly, background UI page 230 processes job 250 by sending the visualization definition of visualization 2 to computing system 130, rendering the visualization received from computing system 130 on background UI page 230, generating an image of the visualization, and sending the image to visualization manager 115. FIG. 6E illustrates GUI 200 while background UI pages 225 and 230 are rendering visualizations 1 and 2, respectively. Thus, GUI 200 still shows the notifications in locations 305 and 310 that visualizations 1 and 2, respectively, are loading.

After background UI pages 225 and 230 finishes processing visualizations 1 and 2, respectively, visualization manager 115 receives the images of them and stores them in images storage 125. Visualization manager 115 then presents the images for visualizations 1 and 2 in locations 305 and 310, respectively, of layout page 300 since these locations are now displayed in display area 240. FIG. 6F illustrates GUI 200 after background UI pages 225 and 230 finished processing visualizations 1 and 2, respectively, and sent the images to visualization manager 115. FIG. 6F also illustrates GUI 200 after visualization manager 115 stored the images in images storage 125 and presented the images in layout page 300. As shown, an image of visualization 1 is presented in location 305 of layout page 300 and an image of visualization 2 is presented in location 310 of layout page 300.

As there is one additional job in work queue 235, background UI pages 225 continues processing jobs in work queue 235. In particular, background UI page 225 takes job 270 off the top of work queue 235 and starts processing it. No jobs are left in work queue 235 so background UI page 230 goes idle. Background UI page 225 processes job 270 by sending the visualization definition of visualization 3 to computing system 130, rendering the visualization received from computing system 130 on background UI page 225, generating an image of the visualization, and sending the image to visualization manager 115. FIG. 6F illustrates GUI 200 while background UI page 225 is rendering visualization 3. FIG. 6G illustrates GUI 200 after background UI page 225 finished processing visualization 3, and sent the image to visualization manager 115. FIG. 6G also illustrates GUI 200 after visualization manager 115 stored the image in images storage 125.

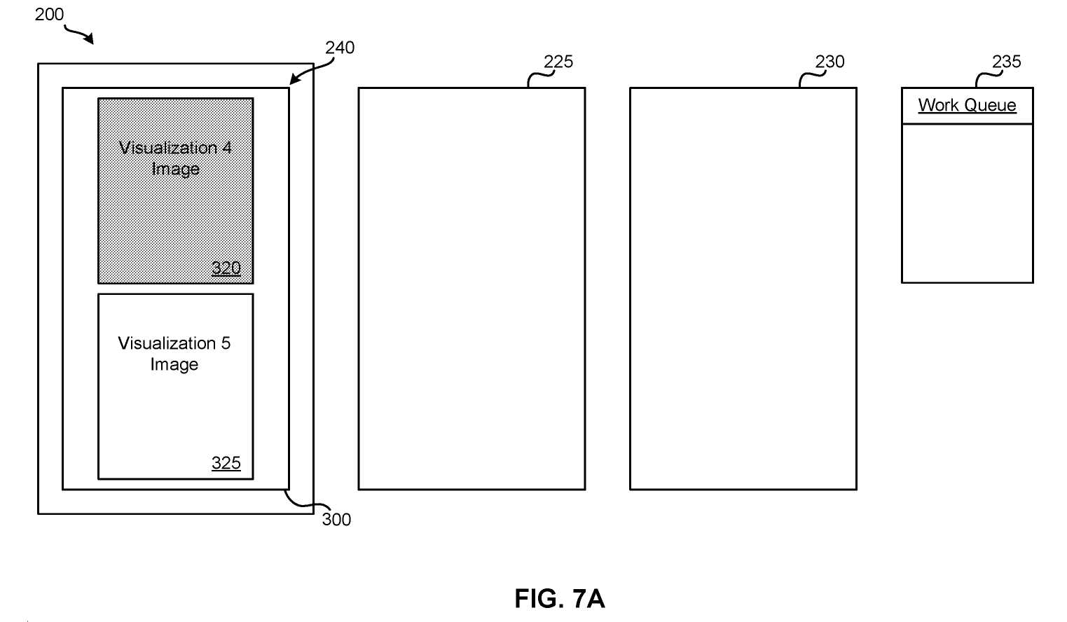

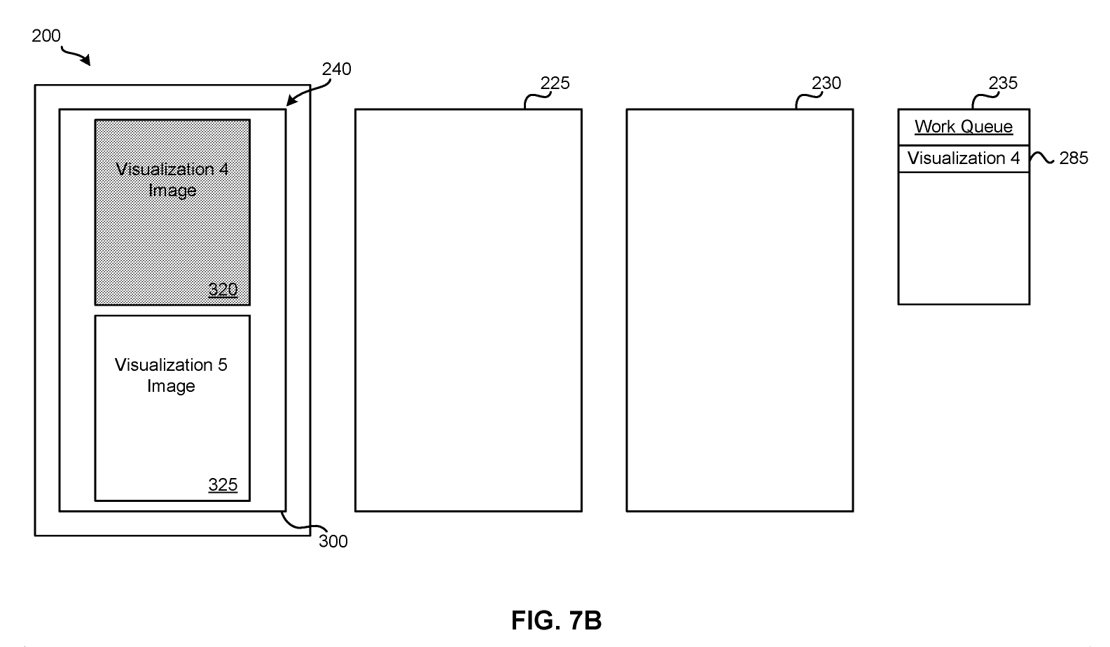

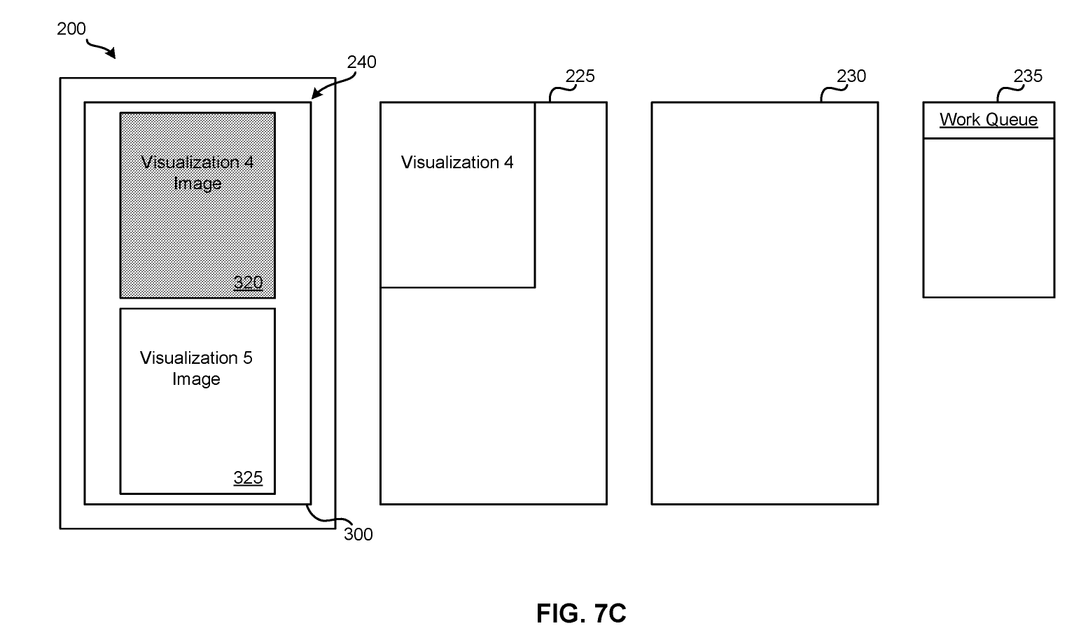

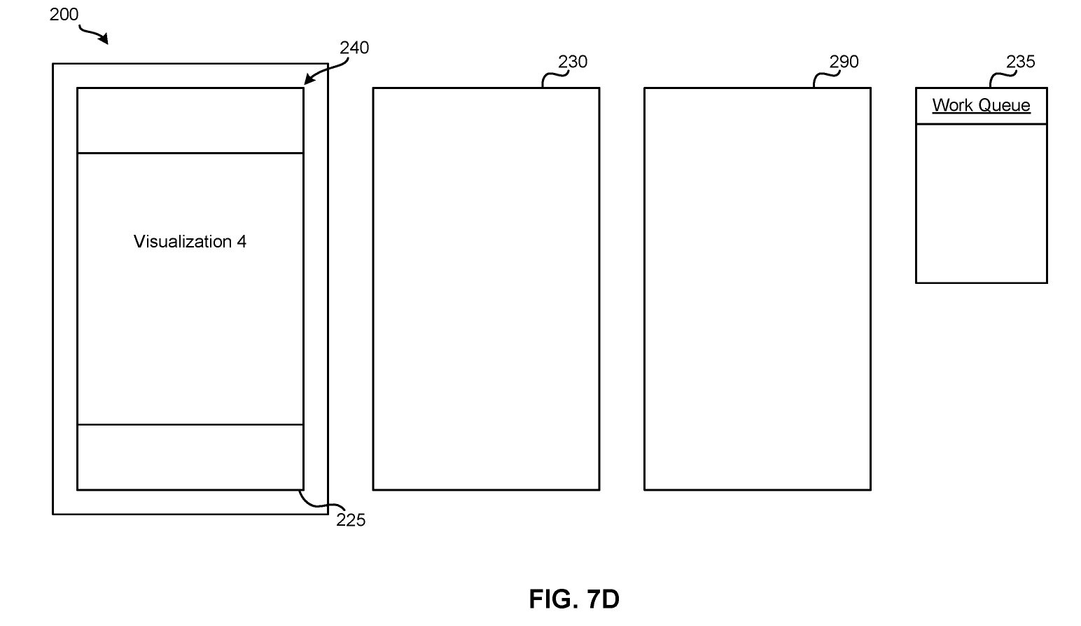

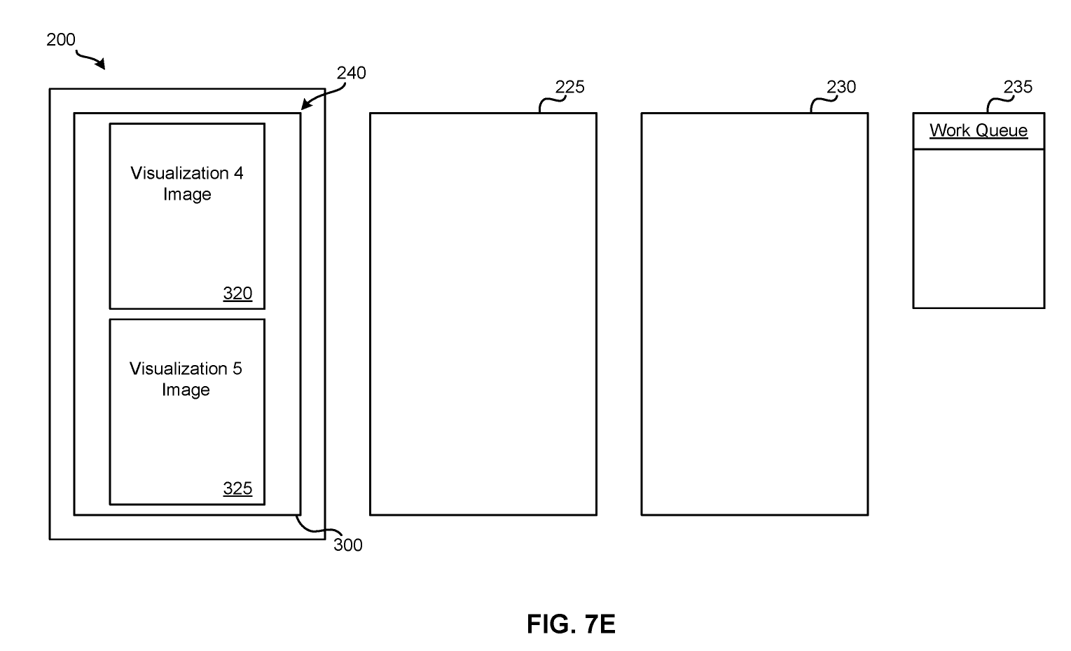

A fifth example operation is interacting with a visualization in a visualization collection. The fifth example operation continues from the stage of the GUI 200 described above by reference to FIG. 5C. For this example, application 110 receives from the user of client device 105 a selection of the image of visualization 4. FIG. 7A illustrates GUI 200 after receiving the selection. As shown, the image of visualization 4 is highlighted to indicate the selection. In response to the selection, application 110 adds a job to work queue 235 for the selected visualization by identifying the visualization definition of the visualization included in the visualization collection definition of visualization collection 2 and then adding it to work queue 235. As shown in FIG. 7B, application 110 added job 285 for visualizations 4 of visualization collection 2 to work queue 235.

After application 110 adds job 285 to work queue 235, application 110 sends background UI manager 120 a request to process jobs in work queue 235. In response, background UI manager 120 instructs background UI pages 225 and 230 to process jobs in work queue 235. In this example, background UI page 225 takes job 285 off the top of work queue 235 and starts processing it. Since there are no jobs left in work queue 235, background UI page 230 goes idle. In the first, second, third, and fourth example operations described above, application 110 was operating in a collection mode. While operating in the collection mode, application 110 presents a layout page of visualizations in a visualization collection (e.g., layout page 300). In addition, when application 110 is operating in the collection mode, background UI pages 225 and 230 processes a visualization by sending the visualization definition of the visualization to computing system 130, rendering the visualization received from computing system 130 on the background UI page, generating an image of the visualization, and sending the image to visualization manager 115. Also, when application 110 is operating in the collection mode, visualization manager 115 presents the corresponding images of visualizations in the locations that are displayed in display area 240.

If an image of a visualization is selected while application 110 is operating in the collection mode, application 110 transitions from operating in the collection mode to operating in an interaction mode. When application 110 is operating in the interaction mode, background UI pages 225 and 230 processes a job in work queue 235 by sending the visualization definition of the selected visualization to computing system 130, and rendering the visualization received from computing system 130 on the background UI page. As such, in this example, background UI page 225 processes job 285 by sending the visualization definition of visualization 4 to computing system 130 and rendering the visualization received from computing system 130 on background UI page 225. FIG. 7C illustrates GUI 200 while background UI page 225 is rendering visualization 4.

When background UI page 225 is done rendering visualization 4, visualization manager 115 resizes visualization 4 to maximize the use of display area 240. In this example, visualization manager 115 enlarges visualization 4 while maintaining the aspect ratio of visualization 4 such that the width of visualization 4 covers the width of display area 240. Then, visualization manager 115 sends background UI page 225 with the resized visualization 4 to application 110 for presentation. Upon receiving background UI page 225, application 110 presents it with the resized visualization 4 in display area 240 in place of layout page 300 so that the user of client device 105 may interact with visualization 4. In addition, application 110 sends background UI manager 120 a request to generate a background UI page to replace background UI page 225. FIG. 7D illustrates GUI 200 after application 110 presents background UI page 225 with resized visualization 4 in display area 240 in place of layout page 300. FIG. 7D also illustrates GUI 200 after background UI manager 120 generates a background UI page to replace background UI image 225. As shown, background UI manager 120 generated background UI page 290. In this example, background UI manager 120 generate background UI page 290 by retrieving a set of libraries (e.g., a set of Javascript libraries) for processing visualizations from computing system 130 and loading the set of libraries onto background UI page 290.

When the user of client device 105 is done interacting with visualization 4, the user may send application 110 a request to exit the interaction mode and return to the collection mode. In response to the request, application 110 transitions from operating in the interaction mode to operating in the collection mode, discards background UI page 225, and presents the same portion of layout page 300 in display area 240 as that displayed in display area 240 before application 110 transitioned to operating in the interaction mode. FIG. 7E illustrates GUI 200 after application 110 transitions from operating in the interaction mode to operating in the collection mode. As shown in FIG. 7E, application 110 is displaying the same portion of layout page 300 in display area 240 as that displayed in display area 240 before application 110 transitioned to operating in the interaction mode, which is illustrated in FIG. 7C.

In some embodiments, background UI manager 120 can monitor the resources consumed by background UI pages. For example, when a background UI page is processing a job from work queue 235 for a defined amount of time without finishing, background UI manager 120 may stop the background UI page from processing the job, place the job back in work queue 235, and then instruct the background UI page to process the next job in work queue 235. As another example, if a background UI page is consuming more than a defined amount of memory, background UI manager 120 may stop the background UI page from processing the job, place the job back in work queue 235, and then instruct the background UI page to process the next job in work queue 235.

Application 110 may reuse images of visualization stored in image storage 125. For instance, if the user of client device 105 selects to view a first visualization collection, which causes images of visualizations in the first visualization collection to be generated, returns to the page of selectable visualization collections associated with the user, selects to view a second visualization collection, returns to the page of selectable visualization collections associated with the user, and then selects to view the first visualization collection again, application 110 may reuse the images of the visualizations in the first visualization collection generated when it was selected to be viewed the first time.

In some instances, an image of a visualization that has been generated and stored in images storage 125 may be regenerated. For example, application 110 may provide a selectable UI item while presenting a visualization collection that, when selected, performs a refresh operation on the visualizations in the visualization collection. When application 110 receives a selection of such a UI item, application 110 adds a job to work queue 235 for each visualization in the visualization collection and then sends background UI manager 120 a request to process jobs in work queue 235. When visualization manager 115 receives an image of a visualization, visualization manager 115 replaces the previous version of the image in images storage 125 with the newly received image. If the location in the layout page of the visualization collection with which the image of the visualization is associated is displayed in displayed area 240, visualization manager 115 presents the newly received image in place of the previous version of the image.

As another example, application 110 can provide a feature for the collection mode that allows filters (e.g., global filters) to be applied to each visualization in a visualization collection. When application 110 receives a request to apply a global filter to a visualization collection, application 110 adds a job to work queue 235 for each visualization in the visualization collection and then sends background UI manager 120 a request to process jobs in work queue 235. When visualization manager 115 receives an image of a visualization with the global filter applied to it, visualization manager 115 replaces the previous version of the image in images storage 125 with the newly received image. If the location in the layout page of the visualization collection with which the image of the visualization is associated is displayed in displayed area 240, visualization manager 115 presents the newly received image in place of the previous version of the image.

As yet another example, application 110 may provide a feature for applying filters to a visualization when the visualization is presented in the interaction mode. If filters are applied to the visualization when transitioning from the interaction mode to the collection mode, application 110 adds a job to work queue 235 for the visualization and then sends background UI manager 120 a request to process jobs in work queue 235. When visualization manager 115 receives an image of a visualization with the filters applied to it, visualization manager 115 replaces the previous version of the image in images storage 125 with the newly received image. If the location in the layout page of the visualization collection with which the image of the visualization is associated is displayed in displayed area 240, visualization manager 115 presents the newly received image in place of the previous version of the image.

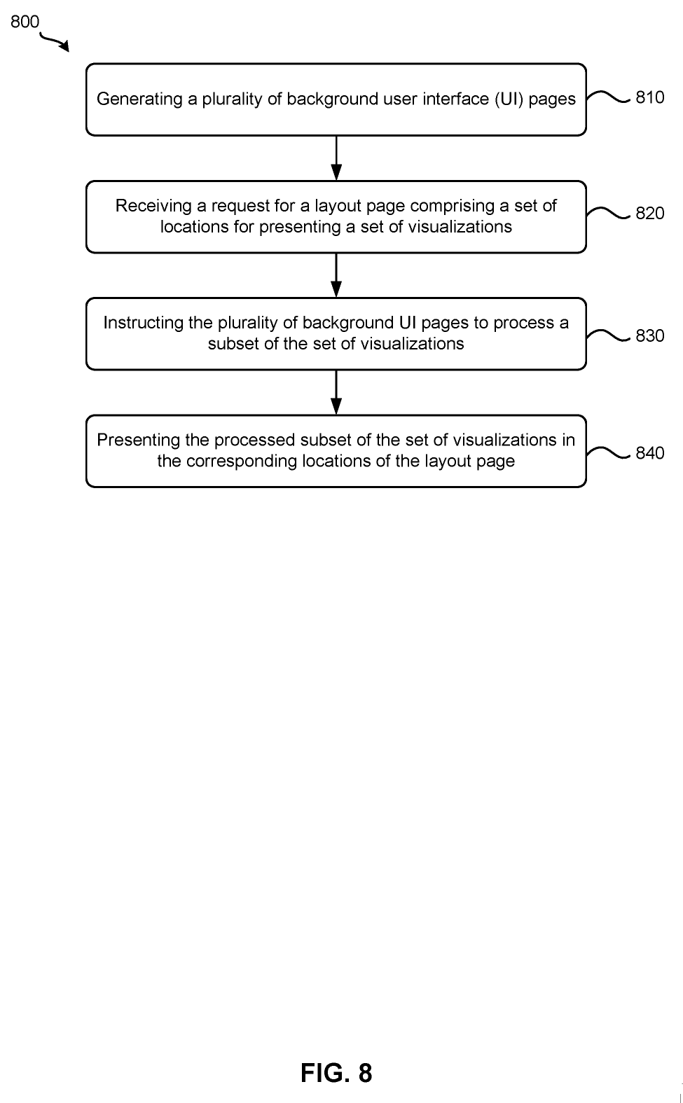

FIG. 8 illustrates process 800 for presenting a visualization collection according to some embodiments. In some embodiments, client device 105 performs process 800. Process 800 begins by generating, at 810, a plurality of background UI pages. As explained above, after application 110 starts and the user of client device 105 has been authenticated, application 110 may send background UI manager 120 a request to generate a defined number of background UI pages (e.g., background UI pages 225 and 230). In some embodiments, a background UI page is an out-of-process browser configured to load and/or render web pages while out of view of a user of client device 105 (e.g., not displayed to the user of client device 105).

Next, process 800 receives, at 820, a request for a layout page comprising a set of locations. Referring to FIGS. 1, 2A, and 3 as an example, application 110 may receive a selection of UI item 210 from a user of client device 105. As mentioned above, a visualization collection associated with UI item 210 includes five visualizations. FIG. 3 illustrates layout page 300, which includes five locations 305-325 that are configured to present the five visualizations in the visualization collection.

Process 800 then instructs, at 830, the plurality of background UI pages to process a subset of the set of visualizations. Referring to FIGS. 1, 2B, and 2C as an example, application 110 determines that locations 305 and 310 are displayed in display area 240 so application 110 adds jobs 245 and 250 to work queue 235 for visualizations 1 and 2, respectively. Application 110 then sends background UI manager 120 a request to process jobs in work queue 235. In response, background UI manager 120 instructs background UI pages 225 and 230 to process jobs in work queue 235. For this example, background UI page 225 takes job 245 off the top of work queue 235 and starts processing it and then background UI page 230 takes job 250 off the top of work queue 235 and starts processing it.

Finally, process 800 presents, at 840, the processed subset of the set of visualizations in the corresponding locations of the layout page. Referring to FIGS. 1 and 2D as an example, background UI page 225 processes job 245 by sending the visualization definition of visualization 1 to computing system 130, rendering the visualization received from computing system 130 on background UI page 225, generating an image of the visualization, and sending the image to visualization manager 115. Similarly, background UI page 230 processes job 250 by sending the visualization definition of visualization 2 to computing system 130, rendering the visualization received from computing system 130 on background UI page 230, generating an image of the visualization, and sending the image to visualization manager 115. When visualization manager 115 receives the images, visualization manager 115 stores it in images storage 125 and then presents the image in the corresponding location of layout page 300. FIG. 2D shows GUI 200 after visualization manager 115 stored the images in images storage 125 and presented an image of visualization 1 in location 305 of layout page 300 and an image of visualization 2 in location 310 of layout page 300.

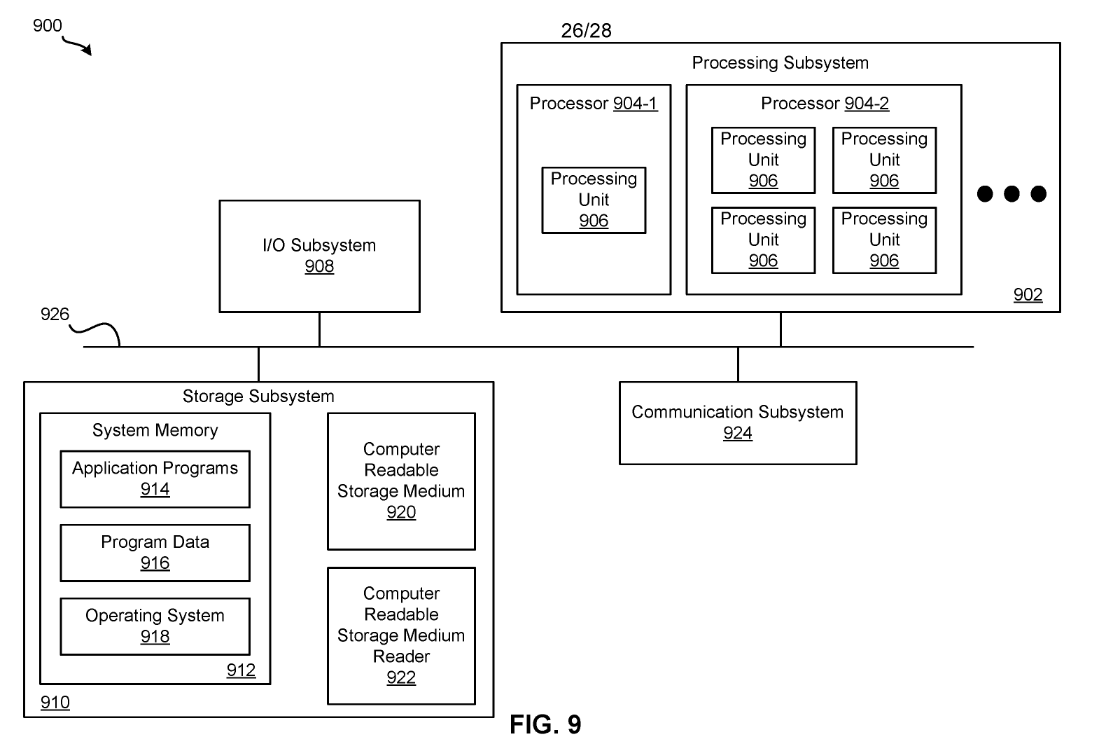

FIG. 9 illustrates an exemplary computer system 900 for implementing various embodiments described above. For example, computer system 900 may be used to implement client device 105 and computing system 130. Computer system 900 may be a desktop computer, a laptop, a server computer, or any other type of computer system or combination thereof. Some or all elements of application 110, visualization manager 115, background UI manager 120, application 135, or combinations thereof can be included or implemented in computer system 900. In addition, computer system 900 can implement many of the operations, methods, and/or processes described above (e.g., process 800). As shown in FIG. 9, computer system 900 includes processing subsystem 902, which communicates, via bus subsystem 926, with input/output (I/O) subsystem 908, storage subsystem 910 and communication subsystem 924.

Bus subsystem 926 is configured to facilitate communication among the various components and subsystems of computer system 900. While bus subsystem 926 is illustrated in FIG. 9 as a single bus, one of ordinary skill in the art will understand that bus subsystem 926 may be implemented as multiple buses. Bus subsystem 926 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 902, which can be implemented as one or more integrated circuits (e.g., a conventional microprocessor or microcontroller), controls the operation of computer system 900. Processing subsystem 902 may include one or more processors 904. Each processor 904 may include one processing unit 906 (e.g., a single core processor such as processor 904-1) or several processing units 906 (e.g., a multicore processor such as processor 904-2). In some embodiments, processors 904 of processing subsystem 902 may be implemented as independent processors while, in other embodiments, processors 904 of processing subsystem 902 may be implemented as multiple processors integrate into a single chip or multiple chips. Still, in some embodiments, processors 904 of processing subsystem 902 may be implemented as a combination of independent processors and multiple processors integrated into a single chip or multiple chips.

In some embodiments, processing subsystem 902 can execute a variety of programs or processes in response to program code and can maintain multiple concurrently executing programs or processes. At any given time, some or all of the program code to be executed can reside in processing subsystem 902 and/or in storage subsystem 910. Through suitable programming, processing subsystem 902 can provide various functionalities, such as the functionalities described above by reference to process 800.

I/O subsystem 908 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 900 to a user or another device (e.g., a printer).

As illustrated in FIG. 9, storage subsystem 910 includes system memory 912, computer-readable storage medium 920, and computer-readable storage medium reader 922. System memory 912 may be configured to store software in the form of program instructions that are loadable and executable by processing subsystem 902 as well as data generated during the execution of program instructions. In some embodiments, system memory 912 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 912 may include different types of memory, such as static random access memory (SRAM) and/or dynamic random access memory (DRAM). System memory 912 may include a basic input/output system (BIOS), in some embodiments, that is configured to store basic routines to facilitate transferring information between elements within computer system 900 (e.g., during start-up). Such a BIOS may be stored in ROM (e.g., a ROM chip), flash memory, or any other type of memory that may be configured to store the BIOS.

As shown in FIG. 9, system memory 912 includes application programs 914 (e.g., application 110 or application 135), program data 916, and operating system (OS) 918. OS 918 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 920 may be a non-transitory computer-readable medium configured to store software (e.g., programs, code modules, data constructs, instructions, etc.). Many of the components (e.g., application 110, visualization manager 115, background UI manager 120, and application 135) and/or processes (e.g., process 800) described above may be implemented as software that when executed by a processor or processing unit (e.g., a processor or processing unit of processing subsystem 902) performs the operations of such components and/or processes. Storage subsystem 910 may also store data used for, or generated during, the execution of the software.

Storage subsystem 910 may also include computer-readable storage medium reader 922 that is configured to communicate with computer-readable storage medium 920. Together and, optionally, in combination with system memory 912, computer-readable storage medium 920 may comprehensively represent remote, local, fixed, and/or removable storage devices plus storage media for temporarily and/or more permanently containing, storing, transmitting, and retrieving computer-readable information.

Computer-readable storage medium 920 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 924 serves as an interface for receiving data from, and transmitting data to, other devices, computer systems, and networks. For example, communication subsystem 924 may allow computer system 900 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 924 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 924 may provide components configured for wired communication (e.g., Ethernet) in addition to or instead of components configured for wireless communication.

One of ordinary skill in the art will realize that the architecture shown in FIG. 9 is only an example architecture of computer system 900, and that computer system 900 may have additional or fewer components than shown, or a different configuration of components. The various components shown in FIG. 9 may be implemented in hardware, software, firmware or any combination thereof, including one or more signal processing and/or application specific integrated circuits.

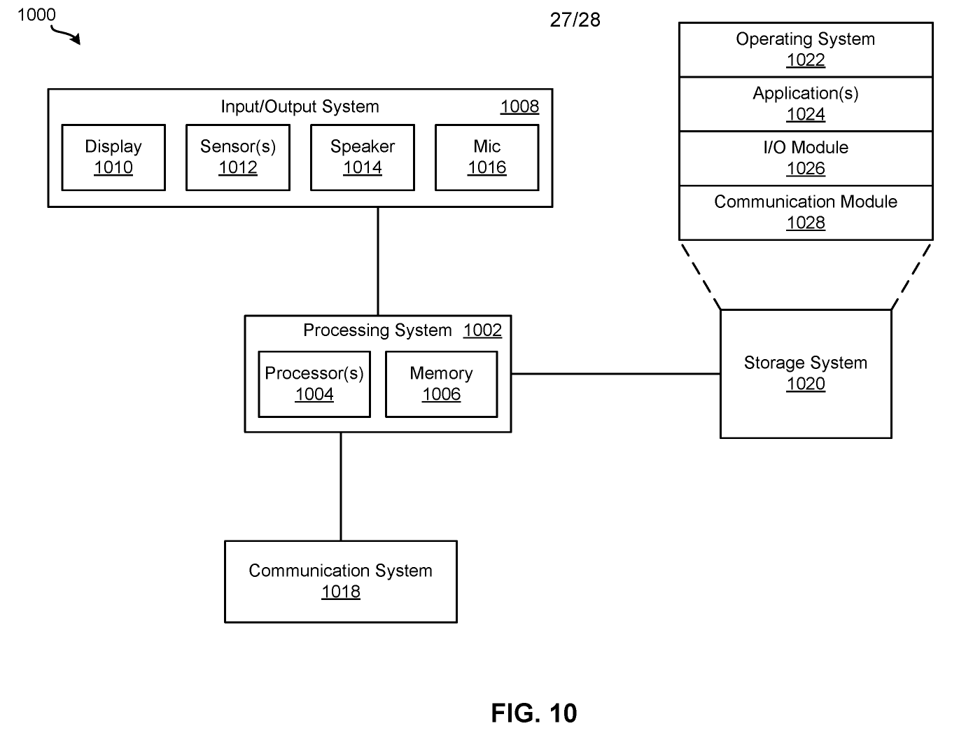

FIG. 10 illustrates an exemplary computing device 1000 for implementing various embodiments described above. For example, computing device 1000 may be used to implement client device 105. Computing device 1000 may be a cellphone, a smartphone, a wearable device, an activity tracker or manager, a tablet, a personal digital assistant (PDA), a media player, or any other type of mobile computing device or combination thereof. Some or all elements of application 110, visualization manager 115, background UI manager 120, or combinations thereof can be included or implemented in computing device 1000. In addition, computing device 1000 can implement many of the operations, methods, and/or processes described above (e.g., process 800). As shown in FIG. 10, computing device 1000 includes processing system 1002, input/output (I/O) system 1008, communication system 1018, and storage system 1020. These components may be coupled by one or more communication buses or signal lines.

Processing system 1002, which can be implemented as one or more integrated circuits (e.g., a conventional microprocessor or microcontroller), controls the operation of computing device 1000. As shown, processing system 1002 includes one or more processors 1004 and memory 1006. Processors 1004 are configured to run or execute various software and/or sets of instructions stored in memory 1006 to perform various functions for computing device 1000 and to process data.

Each processor of processors 1004 may include one processing unit (e.g., a single core processor) or several processing units (e.g., a multicore processor). In some embodiments, processors 1004 of processing system 1002 may be implemented as independent processors while, in other embodiments, processors 1004 of processing system 1002 may be implemented as multiple processors integrate into a single chip. Still, in some embodiments, processors 1004 of processing system 1002 may be implemented as a combination of independent processors and multiple processors integrated into a single chip.

Memory 1006 may be configured to receive and store software (e.g., operating system 1022, applications 1024, I/O module 1026, communication module 1028, etc. from storage system 1020) in the form of program instructions that are loadable and executable by processors 1004 as well as data generated during the execution of program instructions. In some embodiments, memory 1006 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1008 is responsible for receiving input through various components and providing output through various components. As shown for this example, I/O system 1008 includes display 1010, one or more sensors 1012, speaker 1014, and microphone 1016. Display 1010 is configured to output visual information (e.g., a graphical user interface (GUI) generated and/or rendered by processors 1004). In some embodiments, display 1010 is a touch screen that is configured to also receive touch-based input. Display 1010 may be implemented using liquid crystal display (LCD) technology, light-emitting diode (LED) technology, organic LED (OLED) technology, organic electro luminescence (OEL) technology, or any other type of display technologies. Sensors 1012 may include any number of different types of sensors for measuring a physical quantity (e.g., temperature, force, pressure, acceleration, orientation, light, radiation, etc.). Speaker 1014 is configured to output audio information and microphone 1016 is configured to receive audio input. One of ordinary skill in the art will appreciate that I/O system 1008 may include any number of additional, fewer, and/or different components. For instance, I/O system 1008 may include a keypad or keyboard for receiving input, a port for transmitting data, receiving data and/or power, and/or communicating with another device or component, an image capture component for capturing photos and/or videos, etc.

Communication system 1018 serves as an interface for receiving data from, and transmitting data to, other devices, computer systems, and networks. For example, communication system 1018 may allow computing device 1000 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1018 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1018 may provide components configured for wired communication (e.g., Ethernet) in addition to or instead of components configured for wireless communication.

Storage system 1020 handles the storage and management of data for computing device 1000. Storage system 1020 may be implemented by one or more non-transitory machine-readable mediums that are configured to store software (e.g., programs, code modules, data constructs, instructions, etc.) and store data used for, or generated during, the execution of the software. Many of the components (e.g., application 110, visualization manager 115, and background UI manager 120) and/or processes (e.g., process 800) described above may be implemented as software that when executed by a processor or processing unit (e.g., processors 1004 of processing system 1002) performs the operations of such components and/or processes.

In this example, storage system 1020 includes operating system 1022, one or more applications 1024, I/O module 1026, and communication module 1028. Operating system 1022 includes various procedures, sets of instructions, software components and/or drivers for controlling and managing general system tasks (e.g., memory management, storage device control, power management, etc.) and facilitates communication between various hardware and software components. Operating system 1022 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 1024 can include any number of different applications installed on computing device 1000. For example, application 110 may be installed on computing device 1000. Other examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1026 manages information received via input components (e.g., display 1010, sensors 1012, and microphone 1016) and information to be outputted via output components (e.g., display 1010 and speaker 1014). Communication module 1028 facilitates communication with other devices via communication system 1018 and includes various software components for handling data received from communication system 1018.

One of ordinary skill in the art will realize that the architecture shown in FIG. 10 is only an example architecture of computing device 1000, and that computing device 1000 may have additional or fewer components than shown, or a different configuration of components. The various components shown in FIG. 10 may be implemented in hardware, software, firmware or any combination thereof, including one or more signal processing and/or application specific integrated circuits.

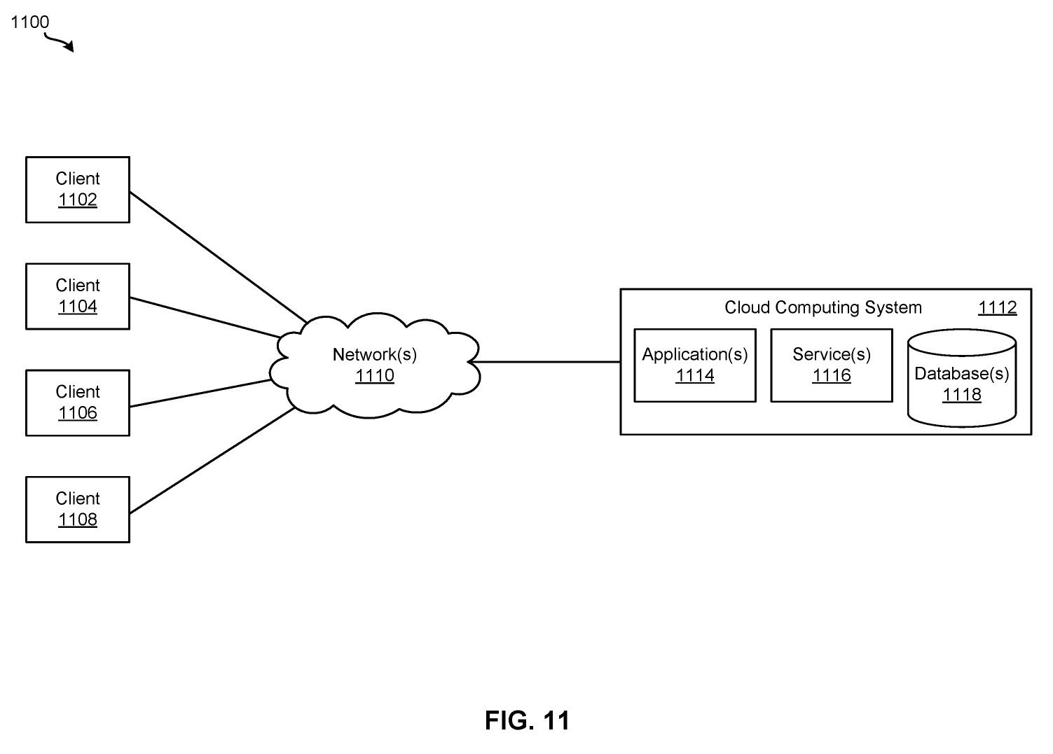

FIG. 11 illustrates an exemplary system 1100 for implementing various embodiments described above. For example, cloud computing system 1112 of system 1100 may be used to implement computing system 130 and one of client devices 1102-1108 may be used to implement client device 105. As shown, system 1100 includes client devices 1102-1108, one or more networks 1110, and cloud computing system 1112. Cloud computing system 1112 is configured to provide resources and data to client devices 1102-1108 via networks 1110. In some embodiments, cloud computing system 1100 provides resources to any number of different users (e.g., customers, tenants, organizations, etc.). Cloud computing system 1112 may be implemented by one or more computer systems (e.g., servers), virtual machines operating on a computer system, or a combination thereof.

As shown, cloud computing system 1112 includes one or more applications 1114, one or more services 1116, and one or more databases 1118. Cloud computing system 1100 may provide applications 1114, services 1116, and databases 1118 to any number of different customers in a self-service, subscription-based, elastically scalable, reliable, highly available, and secure manner.

In some embodiments, cloud computing system 1100 may be adapted to automatically provision, manage, and track a customer's subscriptions to services offered by cloud computing system 1100. Cloud computing system 1100 may provide cloud services via different deployment models. For example, cloud services may be provided under a public cloud model in which cloud computing system 1100 is owned by an organization selling cloud services and the cloud services are made available to the general public or different industry enterprises. As another example, cloud services may be provided under a private cloud model in which cloud computing system 1100 is operated solely for a single organization and may provide cloud services for one or more entities within the organization. The cloud services may also be provided under a community cloud model in which cloud computing system 1100 and the cloud services provided by cloud computing system 1100 are shared by several organizations in a related community. The cloud services may also be provided under a hybrid cloud model, which is a combination of two or more of the aforementioned different models.

In some instances, any one of applications 1114, services 1116, and databases 1118 made available to client devices 1102-1108 via networks 1110 from cloud computing system 1100 is referred to as a “cloud service.” Typically, servers and systems that make up cloud computing system 1100 are different from the on-premises servers and systems of a customer. For example, cloud computing system 1100 may host an application and a user of one of client devices 1102-1108 may order and use the application via networks 1110.

Applications 1114 may include software applications that are configured to execute on cloud computing system 1112 (e.g., a computer system or a virtual machine operating on a computer system) and be accessed, controlled, managed, etc. via client devices 1102-1108. In some embodiments, applications 1114 may include server applications and/or mid-tier applications (e.g., HTTP (hypertext transport protocol) server applications, FTP (file transfer protocol) server applications, CGI (common gateway interface) server applications, JAVA server applications, etc.). Services 1116 are software components, modules, application, etc. that are configured to execute on cloud computing system 1112 and provide functionalities to client devices 1102-1108 via networks 1110. Services 1116 may be web-based services or on-demand cloud services.

Databases 1118 are configured to store and/or manage data that is accessed by applications 1114, services 1116, and/or client devices 1102-1108. For instance, data storage 140 may be stored in databases 1118. Databases 1118 may reside on a non-transitory storage medium local to (and/or resident in) cloud computing system 1112, in a storage-area network (SAN), on a non-transitory storage medium local located remotely from cloud computing system 1112. In some embodiments, databases 1118 may include relational databases that are managed by a relational database management system (RDBMS). Databases 1118 may be a column-oriented databases, row-oriented databases, or a combination thereof. In some embodiments, some or all of databases 1118 are in-memory databases. That is, in some such embodiments, data for databases 1118 are stored and managed in memory (e.g., random access memory (RAM)).

Client devices 1102-1108 are configured to execute and operate a client application (e.g., a web browser, a proprietary client application, etc.) that communicates with applications 1114, services 1116, and/or databases 1118 via networks 1110. This way, client devices 1102-1108 may access the various functionalities provided by applications 1114, services 1116, and databases 1118 while applications 1114, services 1116, and databases 1118 are operating (e.g., hosted) on cloud computing system 1100. Client devices 1102-1108 may be computer system 900 or computing device 1000, as described above by reference to FIGS. 9 and 10, respectively. Although system 1100 is shown with four client devices, any number of client devices may be supported.

Networks 1110 may be any type of network configured to facilitate data communications among client devices 1102-1108 and cloud computing system 1112 using any of a variety of network protocols. Networks 1110 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A non-transitory machine-readable medium storing a program executable by at least one processing unit of a device, the program comprising sets of instructions for:
generating a plurality of background user interface (UI) pages;
receiving a request for a layout page comprising a set of locations for presenting a set of visualizations;
instructing the plurality of background UI pages to process a subset of the set of visualizations;
presenting the processed subset of the set of visualizations in the corresponding locations of the layout page.

2. The non-transitory machine-readable medium of claim 1, wherein a background UI page in the plurality of background UI pages processes a visualization in the subset of the set of visualizations by sending a visualization definition to a computing system, receiving the visualization from the computing system, rendering the visualization on the background UI page, and generating an image of the visualization.

3. The non-transitory machine-readable medium of claim 2, wherein presenting the processed subset of the set of visualizations comprises presenting the generated images of the subset of the set of visualizations in the corresponding locations of the layout page.

4. The non-transitory machine-readable medium of claim 1, wherein the subset of the set of visualizations is a first subset of the set of visualizations, wherein the program further comprises sets of instructions for:
receiving input to scroll the layout page to display a second subset of the set of visualizations;
instructing the plurality of background UI pages to process the second subset of the set of visualizations; and
presenting the processed second subset of the set of visualizations in the corresponding locations of the layout page.

5. The non-transitory machine-readable medium of claim 1, wherein the program further comprises a set of instructions for adding a set of jobs for the subset of the set of visualizations to a work queue.

6. The non-transitory machine-readable medium of claim 5, wherein instructing the plurality of background UI pages to process the subset of the set of visualizations comprises instructing the plurality of background UI page to process jobs from the work queue.

7. The non-transitory machine-readable medium of claim 1, wherein the subset of locations comprises locations in the set of locations have been displayed in a display area of a graphical user interface (GUI) through which the layout page is presented.

8. A method comprising:
generating a plurality of background user interface (UI) pages;
receiving a request for a layout page comprising a set of locations for presenting a set of visualizations;
instructing the plurality of background UI pages to process a subset of the set of visualizations;
presenting the processed subset of the set of visualizations in the corresponding locations of the layout page.

9. The method of claim 8, wherein a background UI page in the plurality of background UI pages processes a visualization in the subset of the set of visualizations by sending a visualization definition to a computing system, receiving the visualization from the computing system, rendering the visualization on the background UI page, and generating an image of the visualization.

10. The method of claim 9, wherein presenting the processed subset of the set of visualizations comprises presenting the generated images of the subset of the set of visualizations in the corresponding locations of the layout page.

11. The method of claim 8, wherein the subset of the set of visualizations is a first subset of the set of visualizations, wherein the method further comprises:
receiving input to scroll the layout page to display a second subset of the set of visualizations;
instructing the plurality of background UI pages to process the second subset of the set of visualizations; and
presenting the processed second subset of the set of visualizations in the corresponding locations of the layout page.

12. The method of claim 8 further comprising adding a set of jobs for the subset of the set of visualizations to a work queue.

13. The method of claim 12, wherein instructing the plurality of background UI pages to process the subset of the set of visualizations comprises instructing the plurality of background UI page to process jobs from the work queue.

14. The method of claim 8, wherein the subset of locations comprises locations in the set of locations have been displayed in a display area of a graphical user interface (GUI) through which the layout page is presented.

15. A system comprising:
a set of processing units; and
a non-transitory computer-readable medium storing instructions that when executed by at least one processing unit in the set of processing units cause the at least one processing unit to:
generate a plurality of background user interface (UI) pages;
receive a request for a layout page comprising a set of locations for presenting a set of visualizations;
instruct the plurality of background UI pages to process a subset of the set of visualizations;
present the processed subset of the set of visualizations in the corresponding locations of the layout page.

16. The system of claim 15, wherein a background UI page in the plurality of background UI pages processes a visualization in the subset of the set of visualizations by sending a visualization definition to a computing system, receiving the visualization from the computing system, rendering the visualization on the background UI page, and generating an image of the visualization.

17. The system of claim 16, wherein presenting the processed subset of the set of visualizations comprises presenting the generated images of the subset of the set of visualizations in the corresponding locations of the layout page.

18. The system of claim 15, wherein the subset of the set of visualizations is a first subset of the set of visualizations, wherein the instructions further cause the at least one processing unit to:
receive input to scroll the layout page to display a second subset of the set of visualizations;
instruct the plurality of background UI pages to process the second subset of the set of visualizations; and
present the processed second subset of the set of visualizations in the corresponding locations of the layout page.

19. The system of claim 15, wherein the instructions further cause the at least one processing unit to add a set of jobs for the subset of the set of visualizations to a work queue.

20. The system of claim 19, wherein instructing the plurality of background UI pages to process the subset of the set of visualizations comprises instructing the plurality of background UI page to process jobs from the work queue.
